(19) United States
(12) Patent Application Publication
(10) Pub. No.: US 2024/0140124 A1
(43) Pub. Date: May 2, 2024

(54) HEAT-SENSITIVE RECORDING MATERIAL AND METHOD OF MANUFACTURING THE SAME

(71) Applicant: OJI HOLDING CORPORATION, Tokyo (JP)

(72) Inventors: Kentaro MOROFUJI, Chuo-ku, Tokyo (JP); Kazuyuki SAKAMOTO, Chuo-ku, Tokyo (JP); Shinya AKIMOTO, Chuo-ku, Tokyo (JP); Takashi TAKEMURA, Chuo-ku, Tokyo (JP)

(73) Assignee: OJI HOLDING CORPORATION, Tokyo (JP)

(21) Appl. No.: 17/769,237

(22) PCT Filed: Oct. 16, 2020
(86) PCT No.: PCT/JP2020/039085

§ 371 Date: Apr. 14, 2022

(30) Foreign Application Priority Data
Oct. 17, 2019 (JP) 2019-190521
Oct. 18, 2019 (JP) 2019-191418
Mar. 3, 2020 (JP) 2020-035978

(51) Int. Cl. B41M 5/333; B41M 5/323; B41M 5/337; B41M 5/42

(52) U.S. Cl. CPC B41M 5/333; B41M 5/323; B41M 5/3377; B41M 5/42; B41M 2205/36; B41M 2205/40

(57) ABSTRACT

Provided is a heat-sensitive recording material that can provide clear and high print image quality with less printing omission, and that has high sensitivity and is excellent in recording density in halftone printing. The heat-sensitive recording material includes an undercoat layer and a heat-sensitive recording layer on a support in this order, in which: the undercoat layer contains hollow particles; the heat-sensitive recording layer contains a leuco dye and a color developer; and the heat-sensitive recording material has one characteristic selected from a group consisting of following (A) to (C): (A) the undercoat layer further contains an adhesive and a water retention agent and a maximum particle size (D100) of the hollow particles is 10 μm to 30 μm; (B) an average particle size (D50) of the hollow particles is 3 μm to 20 μm and the heat-sensitive recording layer further contains an inorganic layered compound; and (C) the undercoat layer further contains an adhesive, the hollow particles include at least two kinds of hollow particles including large particle size hollow particles and small particle size hollow particles, a maximum particle size (D100) of the large particle size hollow particles is 10 μm to 80 μm, an average particle size (D50) of the large particle size hollow particles is 7.5 μm to 25 μm, and an average particle size (D50) of the small particle size hollow particles is 0.7 μm to 6 μm.

### TECHNICAL FIELD

The present invention relates to a heat-sensitive recording material.

### BACKGROUND ART

A heat-sensitive recording material with which a color image is recorded using a thermal color development reaction of a colorless or pale color leuco dye and a phenol or an organic acid has been widely put into practice. Simply by heating this heat-sensitive recording material, a color image is formed. Therefore, a recording apparatus can be made compact, and the maintenance of the recording apparatus is also easy. Therefore, there is an advantageous effect in that the generation of noise is small. Therefore, the heat-sensitive recording material is widely used as various information recoding materials in, for example, issuing machines such as label printers, automatic ticket machines, CDs and ATMs, order form printing machines for restaurants and the like, or data output machines in equipment for scientific research.

As the use of the heat-sensitive recording material has been diversified, demand for improvement of the performance of the heat-sensitive recording material has increased. That is, there are demands for quality such as development of a high-density clear image, suppression of formation of white spots (printing omission), and high image quality.

Therefore, in order to satisfy the demands, many improvement techniques have developed. For example, a method improving the sensitivity of a heat-sensitive recording material is known in which an undercoat layer provided between a support and a heat-sensitive recording layer contains hollow particles to improve thermal insulation properties of the undercoat layer. With regard to the method in which the undercoat layer contains hollow particles, many improvement techniques have been developed.

For example, PTL 1 discloses a heat-sensitive recording material including hollow particles, in which in a undercoat layer containing hollow particles and a binder resin, a hollow ratio is 60% to 98%, a maximum particle size (D100) of the hollow particles is 5.0 μm to 10.0 μm, and a ratio D100/D50 of the maximum particle size to a particle size (D50) corresponding to 50 vol % frequency is 1.5 to 3.0.

In addition, PTL 2 discloses that, with regard to resin particles that are preferable as thermally expandable resin particles used for an undercoat layer, an average particle size of the resin particles before expansion is preferably 1 μm to 25 μm, the volume of the resin particles expands by 10 times to 50 times during heating, and a hollow ratio is 80% or more.

In addition, PTL 3 discloses a heat-sensitive recording material in which, as hollow particles, a mixture of hollow particles A having a particle size of 1 μm or less and a hollow ratio of 80% or less and hollow particles B having a particle size of 3 μm to 10 μm and a hollow ratio of 80% or more is used.

### CITATION LIST

### Patent Literature

PTL 1: Japanese Patent No. 4108380
PTL 2: Japanese Patent No. 5781885
PTL 3: Japanese Patent No. 3176693

### SUMMARY OF THE INVENTION

In the heat-sensitive recording material described in PTL 1, the maximum particle size (D100) of the hollow particles is small at 5.0 μm to 10.0 μm, and thermal insulation properties are insufficient. Therefore, printing energy is likely to be diffused, and there is room for improvement of recording density.

With regard to the heat-sensitive recording material described in PTL 2, there is no viewpoint of making the particle sizes of the thermally expandable resin particles uniform, and a variation in particle size after foaming is large. As a result, surface smoothness of the undercoat layer deteriorates, and thus there is room for improvement of image quality.

In the heat-sensitive recording material described in PTL 3, the particle size of the hollow particles is small, and thermal insulation properties are insufficient. Therefore, printing energy is likely to be diffused, and there is room for improvement of recording density. In addition, the particle size of the hollow particles is small, and cushioning properties of the coating layer are low. Therefore, there is room for improvement of print image quality.

The present invention has been made under these circumstances. That is, a first object of the present invention is to provide a heat-sensitive recording material that can provide clear and high print image quality with less printing omission, and that has high sensitivity and is excellent in recording density in halftone printing.

A second object of the present invention is to provide a heat-sensitive recording material that can provide clear and high print image quality with less printing omission, and that is excellent in maximum recording density.

A third object of the present invention is to provide a heat-sensitive recording material that has an excellent image quality with less printing omission and that is excellent in halftone print density.

In order to achieve the above-described objects, the present inventors conducted a thorough investigation.

Regarding the first object, the present inventors conducted an investigation on hollow particles used for an undercoat layer. As a result, it was found that, by using coarse hollow particles and further using a water retention agent, the first object can be achieved.

Regarding the second object, the present invention conducted an investigation on hollow particles used for an undercoat layer and an inorganic compound used for a heat-sensitive recording layer. As a result, it was found that, by using relatively coarse hollow particles and further using an inorganic layered compound, the second object can be achieved.

Regarding the third object, the present inventors conducted an investigation on hollow particles used for an undercoat layer. As a result, by forming an undercoat layer that contains two kinds of hollow particles having different maximum particle sizes and that contains specific amounts of the hollow particles in a specific particle size distribution, the third object can be achieved.

The present invention was completed through further investigations in consideration of the above-described findings. That is, the present invention has the following configurations.
Item 1: A heat-sensitive recording material including an undercoat layer and a heat-sensitive recording layer on a support in this order, in which:
   the undercoat layer contains hollow particles;
   the heat-sensitive recording layer contains a leuco dye and a color developer; and
   the heat-sensitive recording material has one characteristic selected from a group consisting of following (A) to (C):
   (A) the undercoat layer further contains an adhesive and a water retention agent and a maximum particle size (D100) of the hollow particles is 10 μm to 30 μm;
   (B) an average particle size (D50) of the hollow particles is 3 μm to 20 μm and the heat-sensitive recording layer further contains an inorganic layered compound; and
   (C) the undercoat layer further contains an adhesive, the hollow particles include at least two kinds of hollow particles including large particle size hollow particles and small particle size hollow particles, a maximum particle size (D100) of the large particle size hollow particles is 10 μm to 80 μm, an average particle size (D50) of the large particle size hollow particles is 7.5 μm to 25 μm, and an average particle size (D50) of the small particle size hollow particles is 0.7 μm to 6 μm.
Item 2: The heat-sensitive recording material according to Item 1, in which the heat-sensitive recording material has the characteristic (A).
Item 3: The heat-sensitive recording material according to Item 2, in which the adhesive in the undercoat layer is a water-dispersible adhesive formed of a water-insoluble resin.
Item 4: The heat-sensitive recording material according to Item 3, in which the water-insoluble resin is a styrene-butadiene copolymer.
Item 5: The heat-sensitive recording material according to Item 4, in which a glass transition temperature of the styrene-butadiene copolymer is 10° C. or lower.
Item 6: The heat-sensitive recording material according to Item 4 or 5, in which an average particle size of the styrene-butadiene copolymer is 150 nm to 300 nm.
Item 7: The heat-sensitive recording material according to any one of Items 2 to 6, in which the water retention agent in the undercoat layer is a water-soluble water retention agent formed of a water-soluble resin.
Item 8: The heat-sensitive recording material according to Item 7, in which the water-soluble resin is at least one kind selected from a group consisting of starch, polyvinyl alcohol, and carboxymethyl cellulose.
Item 9: The heat-sensitive recording material according to any one of Items 2 to 8, in which a hollow ratio of the hollow particles is 65% or more.
Item 10: The heat-sensitive recording material according to any one of Items 2 to 9, in which a content ratio of the hollow particles is 5 mass % to 90 mass % with respect to a total solid content of the undercoat layer.
Item 11: A method of manufacturing the heat-sensitive recording material according to any one of Items 2 to 10, the method including a step of applying an undercoat layer-forming coating material containing hollow particles, an adhesive, and a water retention agent using a curtain coating method.
Item 12: The heat-sensitive recording material according to Item 1, in which the heat-sensitive recording material has the characteristic (B).
Item 13: The heat-sensitive recording material according to Item 12, in which the inorganic layered compound is a water-swellable synthetic mica.
Item 14: The heat-sensitive recording material according to Item 12 or 13, in which an average particle size of the inorganic layered compound is 2 μm to 15 μm.
Item 15: A method of manufacturing the heat-sensitive recording material according to any one of Items 12 to 14, the method including a step of applying a heat-sensitive recording layer-forming coating material containing a leuco dye, a color developer, and an inorganic layered compound using a curtain coating method.
Item 16: The heat-sensitive recording material according to Item 1, in which the heat-sensitive recording material has the characteristic (C).
Item 17: The heat-sensitive recording material according to Item 16, in which the maximum particle size (D100) of the large particle size hollow particles is 10 μm to 50 μm and an average particle size (D50) of the large particle size hollow particles is 7.5 μm to 15 μm.
Item 18: The heat-sensitive recording material according to Item 16 or 17, in which D100/D50 of the large particle size hollow particles is 1.8 to 10.0.
Item 19: The heat-sensitive recording material according to any one of Items 16 to 18, in which a hollow ratio of the large particle size hollow particles is 80% to 98% and a hollow ratio of the small particle size hollow particles is less than 80%.
Item 20: The heat-sensitive recording material according to any one of Items 16 to 19, in which the undercoat layer contains 5 mass % to 40 mass % of the large particle size hollow particles.
Item 21: The heat-sensitive recording material according to any one of Items 16 to 20, wherein a coating amount of the undercoat layer after drying is 2.0 g/m² to 10 g/m².
Item 22: The heat-sensitive recording material according to any one of Items 16 to 21, in which a ratio of the small particle size hollow particles to 1 part by mass of the large particle size hollow particles is 0.1 parts by mass to 10 parts by mass.
Item 23: The heat-sensitive recording material according to any one of Items 16 to 22, in which a maximum particle size (D100) of the small particle size hollow particles is 1 μm to 7 μm.
Item 24: The heat-sensitive recording material according to any one of Items 16 to 23, in which styrene-butadiene latex is contained as the adhesive.
Item 25: The heat-sensitive recording material according to Item 24, in which a glass transition temperature (Tg) of the styrene-butadiene latex is −10° C. or lower (preferably −30° C. or lower).
Item 26: A method of manufacturing the heat-sensitive recording material according to any one of Items 16 to 25, the method including a step of applying an undercoat layer-forming coating material containing hollow particles and an adhesive using a curtain coating method,
   in which the hollow particles include at least two kinds of hollow particles including large particle size hollow particles and small particle size hollow particles, a maximum particle size (D100) of the large particle size hollow particles is 10 μm to 80 μm, an average particle size (D50) of the large particle size hollow particles is 7.5 μm to 25 μm, and an average particle size (D50) of the small particle size hollow particles is 0.7 μm to 6 μm.

### Effects of the Invention

Provided is a heat-sensitive recording material that can provide clear and high print image quality with less printing omission, and that has high sensitivity and is excellent in recording density (or print density) in halftone printing.

### MODES FOR CARRYING OUT THE INVENTION

An embodiment of the present invention will be described. The embodiment of the present invention is not limited to the following embodiment. In the present specification, the expression “includes, contains” includes the concepts of “including”, “including substantially only”, and “including only”.

The present invention relates to a heat-sensitive recording material including an undercoat layer and a heat-sensitive recording layer on a support (in particular, on one surface of the support) in this order, wherein:
the undercoat layer contains hollow particles;
the heat-sensitive recording layer contains a leuco dye and a color developer; and
the heat-sensitive recording material has one characteristic selected from the group consisting of the following (A) to (C):
(A) the undercoat layer further contains an adhesive and a water retention agent and a maximum particle size (D100) of the hollow particles is 10 μm to 30 μm;
(B) an average particle size (D50) of the hollow particles is 3 μm to 20 μm and the heat-sensitive recording layer further contains an inorganic layered compound; and
(C) the undercoat layer further contains an adhesive, the hollow particles include at least two kinds of hollow particles including large particle size hollow particles and small particle size hollow particles, a maximum particle size (D100) of the large particle size hollow particles is 10 μm to 80 μm, an average particle size (D50) of the large particle size hollow particles is 7.5 μm to 25 μm, and an average particle size (D50) of the small particle size hollow particles is 0.7 μm to 6 μm.

The heat-sensitive recording material having the characteristics (A) to (C) will be referred to as heat-sensitive recording materials (A) to (C), respectively, in the following description.

A. Heat-Sensitive Recording Material (A)

The heat-sensitive recording material (A) includes an undercoat layer and a heat-sensitive recording layer on a support in this order, the undercoat layer containing hollow particles, an adhesive, and a water retention agent, and the heat-sensitive recording layer containing a leuco dye and a color developer, in which a maximum particle size (D100) of the hollow particles is 10 μm to 30 μm.

[Support]

The kind, shape, dimension, and the like of the support according to the embodiment are not particularly limited. For example, as the support, a support can be appropriately selected and used from high-quality paper (acid paper, neutral paper), medium-quality paper, coated paper, art paper, cast-coated paper, glassine paper, resin laminate paper, polyolefin synthetic paper, synthetic fiber paper, non-woven fabrics, synthetic resin films, and various transparent supports. The thickness of the support is not particularly limited and is typically about 20 μm to 200 μm. In addition, the density of the support is not particularly limited and is preferably about 0.60 g/cm³ to 0.85 g/cm³.

[Undercoat Layer]

In the heat-sensitive recording material according to the embodiment, the undercoat layer is provided between the support and the heat-sensitive recording layer. The undercoat layer contains hollow particles having a maximum particle size (D100) of 10 μm to 30 μm and further contains an adhesive and a water retention agent.

(Hollow Particles)

From the viewpoint of improving cushioning properties, it is preferable that the hollow particles should be formed of an organic resin. The undercoat layer that has high thermal insulation properties by containing the hollow particles suppresses diffusion of heat applied to the heat-sensitive recording layer and can improve sensitivity as the heat-sensitive recording material.

Hollow particles formed of an organic resin can be classified into a foaming type and a non-foaming type depending on manufacturing methods. Regarding the two types, in general, the average particle size and the hollow ratio of the foaming type hollow particles are greater than those of the non-foaming type hollow particles. Therefore, with the foaming type hollow particles, higher sensitivity and image quality can be obtained as compared to the non-foaming type hollow particles. However, the smoothness of the undercoat layer tends to decrease. Therefore, by containing a water retention agent, migration of the adhesive to the support side can be suppressed, and the smoothness can be improved while the thickness of the coating layer is maintained.

Hereinafter, a representative method of manufacturing the foaming type hollow particles will be described.

First, particles in which volatile liquid is sealed in a resin are prepared, and the resin is softened during heating while vaporizing and expanding the liquid in the particles. As a result, the hollow particles can be manufactured.

Regarding the foaming type hollow particles, the liquid in the particles are heated to expand in the process of manufacturing such that the hollow ratio increases and high thermal insulation properties can be obtained. Therefore, the sensitivity of the heat-sensitive recording material can be improved, and the recording density can be improved. The improvement of the sensitivity is important when a halftone region where thermal energy applied to the heat-sensitive recording layer is low is colored. In addition, when the heat-sensitive recording layer is formed through the undercoat layer having high thermal insulation properties, diffusion of heat applied to the heat-sensitive recording layer is suppressed, and thus, image uniformity becomes excellent, and image quality can also be improved. Therefore, in the embodiment, it is preferable to use the foaming type hollow particle that is suitable for improvement of the thermal insulation properties of the undercoat layer.

Examples of the resin that can be used for the foaming type hollow particles include a thermoplastic resin, for example, a styrene-acrylic resin, a polystyrene resin, an acrylic resin, a polyethylene resin, a polypropylene resin, a polyacetal resin, a chlorinated polyether resin, a polyvinyl chloride resin, a polyvinylidene chloride resin, an acrylic resin (for example, an acrylic resin containing acrylonitrile as a component), a styrene resin, or a copolymer resin, such as a vinylidene chloride resin, mainly formed of polyvinylidene chloride and acrylonitrile. As gas in the foaming type hollow particles, for example, propane, butane, isobutane, or air can be generally used.

As the resin used for the hollow particles, an acrylonitrile resin or a copolymer resin mainly formed of polyvinylidene chloride and acrylonitrile is preferable from the viewpoint of the strength for maintaining the shape of foamed particles, among the various resins described above.

On the other hand, with regard to the non-foaming type hollow particles, in general, the average particle size is small, and the hollow ratio is also low. Therefore, in order to obtain excellent sensitivity and image quality, it is preferable to increase the content of the hollow particles in the undercoat layer.

In a method of manufacturing the non-foaming type hollow particles, a seed is polymerized in a solution, another resin is polymerized to cover the seed, and the seed in the resin is removed by swelling and dissolution. As a result, voids are formed in the resin. In order to remove the seed in the resin by swelling and dissolution, an alkaline aqueous solution or the like is used. By performing an alkali swelling process on core-shell particles in which core particles having alkali swellability are covered with a shell layer having no alkali swellability, the non-foaming type hollow particles having a relatively large average particle size can also be obtained.

Examples of a monomer that is suitable for the method of manufacturing the non-foaming type hollow particles include a vinyl monomer, such as a styrene monomer, an acrylic monomer, or an acrylonitrile monomer. Examples of the styrene monomer include styrene, methylstyrene, dimethylstyrene, trimethylstyrene, ethylstyrene, diethylstyrene, triethylstyrene, propylstyrene, butylstyrene, chlorstyrene, and t-butylstyrene. Examples of the acrylic monomer include methyl acrylate, ethyl acrylate, n-butyl acrylate, isobutyl acrylate, 2-ethylhexyl acrylate, cyclohexyl acrylate, methyl methacrylate, ethyl methacrylate, n-butyl methacrylate, isobutyl methacrylate, 2-ethylhexyl methacrylate, and cyclohexyl methacrylate. Examples of the acrylonitrile monomer include acrylonitrile and methacrylonitrile. Examples of other vinyl monomers include dimethyl maleate, dimethyl fumarate, maleic anhydride, N-methylmaleimide, and N-phenylmaleimide.

Among the various monomers described above, from the viewpoint of easy manufacturing, a combination of a styrene monomer and an acrylic monomer is preferable, and a combination of a styrene monomer and a (meth)acrylate is more preferable. That is, it is preferable that the hollow particles should be formed of a styrene-acrylic resin, and it is more preferable that the hollow particles are formed of a styrene-(meth)acrylate copolymer resin.

The maximum particle size of the hollow particles in the embodiment is 10 μm to 30 μm and preferably 15 μm to 25 μm. The maximum particle size will also be represented by D100.

When the maximum particle size of the hollow particles is 10 μm or more, the cushioning properties of the undercoat layer are improved. Therefore, adhesion of the heat-sensitive recording material with a thermal head during printing is improved, and a heat-sensitive recording material having high image quality can be obtained. This high image quality can bring about improvement of recording density in a halftone region that is colored with lower energy than the energy for providing the maximum recording density (Dmax).

On the other hand, when the maximum particle size of the hollow particles is 30 μm or less, the smoothness of the undercoat layer is improved. Therefore, the heat-sensitive recording layer that is provided through the undercoat layer can be made uniform, and the heat-sensitive recording material in which the formation of white spots in an image is not likely to occur can be obtained.

The maximum particle size (D100) and the average particle size (D50) of the hollow particles can be measured using a laser diffraction particle size analyzer. In addition, the maximum particle size (D100) and the average particle size (D50) may be obtained by measuring the particle sizes from particle images (SEM images) using an electron microscope and obtaining the average values of 10 particle sizes.

The hollow ratio of the hollow particles is preferably 65% or more, more preferably 70% or more, and still more preferably 80% or more.

The hollow ratio of the hollow particles is obtained from the value of true specific gravity that is measured using an IPA method.
(1) Pretreatment of Sample
   A sample is dried overnight at 60° C.
(2) Reagent
   Isopropyl alcohol (IPA: Extra Pure Reagent)
(3) Measurement Method
   A volumetric flask is weighed (W1).
   About 0.5 g of the dried sample is weighed in the volumetric flask (W2).
   About 50 mg of IPA is added and is sufficiently shaken to completely remove air outside a capsule.
   IPA is added up to a marked line and weighed (W3).
   As a blank sample, only IPA is added up to a marked line and weighed in the volumetric flask (W4).
(4) Calculation of True Specific Gravity

True specific gravity={(W2−W1)×(W4−W1)/100}/(W4−W1)−(W3−W2)}
(5) Calculation of Hollow Ratio

Hollow Ratio (%)={1−1/(1.1/True Specific Gravity)}×100

In addition, the hollow ratio is a value obtained from the following expression (d³/D³)×100. In the expression, d represents the inner diameter of the hollow particles, and D represents the outer diameter of the hollow particles. The average particle size of the hollow particles is preferably about 0.5 μm to 12 μm and more preferably about 3 μm to 12 μm.

The content ratio of the hollow particles with respect to the total solid content of the undercoat layer is preferably 5 mass % to 90 mass %, more preferably 5 mass % to 70 mass %, still more preferably 5 mass % to 50 mass %, and still more preferably 10 mass % to 50 mass %. When the content ratio of the hollow particles is 5 mass % or more, the thermal insulation properties of the undercoat layer can be improved. On the other hand, when the content ratio of the hollow particles is 90 mass % or less, a problem is not likely to occur in terms of coating properties or the like, a uniform undercoat layer is likely to be formed, and the recording density can be improved.

In addition, it is preferable that an oil-absorbing pigment should be added to the undercoat layer. By adding the oil-absorbing pigment to the undercoat layer, printing failures such as sticking or remaining of residues on a thermal head can be effectively suppressed. Examples of the oil-absorbing pigment include fired kaolin. The content ratio of the oil-absorbing pigment with respect to the total solid content of the undercoat layer is preferably 2 mass % to 80 mass %.

(Adhesive)

As the adhesive, a water-dispersible adhesive formed of a water-insoluble resin is preferable. Examples of the water-dispersible adhesive include a latex, such as polyvinyl acetate, polyurethane, a styrene-butadiene copolymer, a styrene-butadiene-acrylonitrile copolymer, an acrylonitrile-butadiene copolymer, polyacrylic acid, a polyacrylate, a vinyl chloride-vinyl acetate copolymer, polybutyl methacrylate, an ethylene-vinyl acetate copolymer, silylated urethane, an acrylic silicon composite, an acrylic silicon urethane composite, an urea resin, a melamine resin, an amide resin, or a polyurethane resin. Among these, a styrene-butadiene copolymer is preferable. The content ratio of the latex can be selected in a wide range and, in general, is preferably 5 mass % or more and more preferably 10 mass % or more with respect to the total solid content of the undercoat layer. On the other hand, the content ratio is preferably 40 mass % or less, more preferably 30 mass % or less, and still more preferably 20 mass % or less. By adjusting the content ratio of the latex to 10 mass % or more, the cushioning properties of the undercoat layer are further improved.

The glass transition temperature (Tg) of the adhesive (in particularly, the latex) is not particularly limited and is preferably 10° C. or lower, more preferably 5° C. or lower, and still more preferably −10° C. or lower. By using the adhesive having a glass transition temperature of 10° C. or lower, the cushioning properties of the undercoat layer are further improved. On the other hand, when the glass transition temperature is −50° C. or lower, sticking is likely to occur, which is not preferable. Therefore, the glass transition temperature is preferably −40° C. or higher.

The average particle size of the adhesive (in particular, the latex) is not particularly limited and is preferably 150 nm or more, more preferably 165 nm or more, and still more preferably 190 nm or more. On the other hand, the glass transition temperature is preferably 300 nm or less and more preferably 250 nm or less. By adjusting the average particle size to 150 nm or more, migration of the latex to the support side is effectively suppressed, and a uniform undercoat layer can be formed. By adjusting the average particle size to 300 nm or less, the formation of voids caused by fusion of the latex is suppressed, penetration of the heat-sensitive recording layer-forming coating material is suppressed, and a uniform heat-sensitive recording layer can be formed.

The average particle size of the adhesive can be measured using a laser diffraction particle size analyzer.

(Water Retention Agent)

The water retention agent is contained in the undercoat layer such that migration of the undercoat layer-forming coating material to the support side, in particular, migration of the adhesive component is suppressed and an undercoat layer where the hollow particles are uniformly distributed without uneven distribution can be formed. When the uneven distribution of the hollow particles decreases, the smoothness of the undercoat layer is improved. Therefore, the heat-sensitive recording layer that is provided through the undercoat layer can be made uniform. As a result, the hollow particles having a relatively large maximum particle size of 10 μm to 30 μm are uniformly distributed in the undercoat layer, the formation of white spots in an image or the like can be suppressed, and the maximum color optical density is also improved. It is preferable that the water retention agent should be a water-soluble water retention agent formed of a water-soluble resin. In the embodiment, when the undercoat layer contains the hollow particles having a maximum particle size (D100) of 10 μm to 30 μm, the water-soluble resin in the undercoat layer corresponds to the water retention agent and does not correspond to the adhesive.

As the water retention agent, for example, various well-known materials, such as cellulose or a derivative thereof, a polymer polysaccharide, a polyacrylic acid modified product, sodium alginate, or a maleic anhydride copolymer can be appropriately used. In particular, it is preferable that the water-soluble resin should be at least one kind selected from the group consisting of starch, polyvinyl alcohol, and carboxymethyl cellulose. Specific examples of the polyvinyl alcohol include a modified polyvinyl alcohol, such as completely saponified polyvinyl alcohol, partially saponified polyvinyl alcohol, carboxy modified polyvinyl alcohol, acetoacetyl modified polyvinyl alcohol, diacetone modified polyvinyl alcohol, or silicon modified polyvinyl alcohol. Specific examples of the starch include starch, oxidized starch, hydroxyethyl starch, and a derivative, such as starch acetate. The content ratio of the water retention agent is not particularly limited and is preferably 0.3 mass % to 5 mass % and more preferably 0.5 mass % to 2 mass % with respect to the total solid content of the undercoat layer. By adjusting the content ratio to 0.3 mass % or more, migration can be more effectively suppressed. By adjusting the content ratio to 5 mass % or less, an increase in the viscosity of the coating material is suppressed, and coating suitability is excellent. In addition, there is no possibility that water resistance deteriorates, expansion (blistering) caused by water penetration occurs, and the undercoat layer is peeled off.

The undercoat layer is formed on the support, in general, by mixing the hollow particles, the adhesive, and the water retention agent and optionally the oil-absorbing pigment, such as fired kaolin, an auxiliary agent, and the like in water as a medium to prepare the undercoat layer-forming coating material, applying the undercoat layer-forming coating material to the support, and performing drying. The coating amount of the undercoat layer-forming coating material is not particularly limited and is preferably about 2 g/m² to 20 g/m² and more preferably about 2 g/m² to 12 g/m² in terms of dry weight.

[Heat-Sensitive Recording Layer]

The heat-sensitive recording layer in the heat-sensitive recording material according to the embodiment can contain various well-known colorless or pale color leuco dyes. Specific examples of the leuco dye are as follows.

Specific examples of the leuco dye include: a blue coloring dye, such as 3,3-bis(p-dimethylaminophenyl)-6-dimethylaminophthalide, 3-(4-diethylamino-2-methylphenyl)-3-(4-dimethylaminophenyl)-6-dimethylaminophthalide, or fluoran; a green coloring dye, such as 3-(N-ethyl-N-p-tolyl)amino-7-N-methylanilinofluoran, 3-diethylamino-7-anilinofluoran, 3-diethylamino-7-dibenzylaminofluoran, or rhodamine B-anilinolactam; a red coloring dye, such as 3,6-bis(diethylamino)fluoran-γ-anilinolactam, 3-cyclohexylamino-6-chlorofluoran, 3-diethylamino-6-methyl-7-chlorofluoran, or 3-diethylamino-7-chlorofluoran; a black coloring dye, such as 3-(N-ethyl-N-isoamyl)amino-6-methyl-7-anilinofluoran, 3-(N-methyl-N-cyclohexyl)amino-6-methyl-7-anilinofluoran, 3-diethylamino-6-methyl-7-anilinofluoran, 3-di(n-butyl)amino-6-methyl-7-anilinofluoran, 3-di(n-pentyl)amino-6-methyl-7-anilinofluoran, 3-(N-ethyl-N-isoamylamino)-6-methyl-7-anilinofluoran, 3-diethylamino-7-(m-trifluoromethylanilino)fluoran, 3-(N-isoamyl-N-ethylamino)-7-(o-chloroanilino)fluoran, 3-(N-ethyl-N-2-tetrahydrofurfurylamino)-6-methyl-7-anilinofluoran, 3-(N-n-hexyl-N-ethylamino)-6-methyl-7-anilinofluoran, 3-[N-(3-ethoxypropyl)-N-ethylamino]-6-methyl-7-anilinofluoran, 3-[N-(3-ethoxypropyl)-N-methylamino]-6-methyl-7-anilinofluoran, 3-diethylamino-7-(2-chloroanilino)fluoran, 3-di(n-butylamino)-7-(2-chloroanilino)fluoran, 4,4′-bis-dimethylaminobenzohydrine benzyl ether, N-2,4,5-trichlorophenyl leucoauramine, 3-diethylamino-7-butylaminofluoran, 3-ethyl-tolylamino-6-methyl-7-anilinofluoran, 3-cyclohexyl-methylamino-6-methyl-7-anilinofluoran, 3-diethylamino-6-chloro-7-(p-ethoxyethyl)aminofluoran, 3-diethylamino-6-chloro-7-(y-chloropropyl)aminofluoran, 3-diethylamino-6-methyl-7-anilinofluoran, 3-(N-isoamyl-N-ethylamino)-6-methyl-7-anilinofluoran, 3-dibutylamino-7-chloroanilinofluoran, 3-diethylamino-7-(o-chlorophenylamino)fluoran, 3-(N-ethyl-p-toluidino)-6-methyl-7-anilinofluoran, 3-(N-ethyl-p-toluidino)-6-methyl-7-(p-toluidino)fluoran, 3-(N-ethyl-N-tetrahydrofurfurylamino)-6-methyl-7-anilinofluoran, 3-diethylamino-6-chloro-7-anilinofluoran, 3-dimethylamino-6-methyl-7-anilinofluoran, 3-pyrrolidino-6-methyl-7-anilinofluoran, 3-piperidino-6-methyl-7-anilinofluoran, 2,2-bis{4-[6′-(N-cyclohexyl-N-methylamino)-3′-methylspiro[phthalide-3,9′-xanthen-2′-yl amino]phenyl}propane, or 3-diethylamino-7-(3′-trifluoromethylphenyl)aminofluoran; a dye having an absorption wavelength in a near infrared range, such as 3,3-bis[1-(4-methoxyphenyl)-1-(4-dimethylaminophenyl)ethylen-2-yl]-4,5,6,7-tetrachlorophthalide, 3,3-bis[1-(4-methoxyphenyl)-1-(4-pyrrolidinophenyl)ethylen-2-yl]-4,5,6,7-tetrachlorophthalide, 3-p-(p-dimethylaminoanilino)anilino-6-methyl-7-chlorofluoran, 3-p-(p-chloroanilino)anilino-6-methyl-7-chlorofluoran, or 3,6-bis(dimethylamino)fluorene-9-spiro-3′-(6′-dimethylamino)phthalide. Obviously, the leuco dye is not limited to these examples. Optionally, two or more compounds can also be used in combination.

The content ratio of the leuco dye is not particularly limited and is preferably about 3 mass % to 30 mass %, more preferably about 5 mass % to 25 mass %, and still more preferably 7 mass % to 20 mass % with respect to the total solid content of the heat-sensitive recording layer. By adjusting the content ratio to 3 mass % or more, the color developability is improved, and the print density can be improved. By adjusting the content ratio to 30 mass % or less, the heat resistance can be improved.

Specific examples of the color developer include: a phenolic compound, such as 4-tert-butylphenol, 4-acetylphenol, 4-tert-octylphenol, 4,4′-sec-butylidenediphenol, 4-phenylphenol, 4,4′-dihydroxydiphenylmethane, 4,4′-isopropylidenediphenol, 4,4′-cyclohexylidenediphenyl, 4,4′-cyclohexylidenediphenol, 1,1-bis(4-hydroxyphenyl)-ethane, 1,1-bis(4-hydroxyphenyl)-1-phenylethane, 4,4′-bis(p-tolylsulfonylaminocarbonylamino)diphenylmethane, 1,1-bis(4-hydroxyphenyl)cyclohexane, 2,2′-bis[4-(4-hydroxyphenyl)phenoxy]diethyl ether, 4,4′-dihydroxydiphenylsulfide, 4,4′-thiobis(3-methyl-6-tert-butylphenol), 4,4′-dihydroxydiphenylsulfone, 2,4′-dihydroxydiphenylsulfone, 2,2-bis(4-hydroxyphenyl)-4-methylpentane, 2,4′-dihydroxydiphenylsulfone, 4-hydroxy-4′-isopropoxydiphenylsulfone, 4-hydroxy-4′-n-propoxydiphenylsulfone, 4-hydroxy-4′-allyloxydiphenylsulfone, 4-hydroxy-4′-benzyloxydiphenylsulfone, 3,3′-diallyl-4,4′-dihydroxydiphenylsulfone, butyl bis(p-hydroxyphenyl)acetate, methyl bis(p-hydroxyphenyl)acetate, hydroquinone monobenzyl ether, bis(3-allyl-4-hydroxyphenyl)sulfone, 4-hydroxy-4′-methyldiphenylsulfone, 4-allyloxy-4′-hydroxydiphenylsulfone, 3,4-dihydroxyphenyl-4′-methylphenylsulfone; 4-hydroxybenzophenone, dimethyl 4-hydroxyphthalate, methyl 4-hydroxybenzoate, propyl 4-hydroxybenzoate, sec-butyl 4-hydroxybenzoate, phenyl 4-hydroxybenzoate, benzyl 4-hydroxybenzoate, benzyl 4-hydroxybenzoate ester, tolyl 4-hydroxybenzoate, chlorophenyl 4-hydroxybenzoate, or 4,4′-dihydroxydiphenyl ether; an aromatic carboxylic acid, such as benzoic acid, p-chlorobenzoic acid, p-tert-butylbenzoic acid, tolylchlorobenzoic acid, terephthalic acid, salicylic acid, 3-tert-butylsalicylic acid, 3-isopropylsalicylic acid, 3-benzylsalicylic acid, 3-(a-methylbenzyl)salicylic acid, 3,5-di-tert-butylsalicylic acid, 4-[2-(p-methoxyphenoxy)ethyloxy]salicylic acid, 4-[3-(p-tolylsulfonyl)propyloxy]salicylic acid, 5-[p-(2-p-methoxyphenoxyethoxy)cumyl]salicylic acid, or zinc 4-{3-(p-tolylsulfonyl)propyloxy]salicylate; a salts of the phenolic compound; a salt of an aromatic carboxylic acid and a polyvalent metal, such as zinc, magnesium, aluminum, calcium, titanium, manganese, tin, or nickel; an organic acidic substance, such as an antipyrine complex of zinc thiocyanate or a composite zinc salt of terephthalic aldehyde acid and another aromatic carboxylic acid; an urea compound, such as N-p-toluenesulfonyl-N′-3-(p-toluenesulfonyloxy)phenylurea, N-p-toluenesulfonyl-N′-p-butoxycarbonylphenylurea, N-p-tolylsulfonyl-N′-phenylurea, 4,4′-bis(p-toluenesulfonylaminocarbonylamino)diphenylmethane, or 4,4′-bis[(4-methyl-3-phenoxycarbonylaminophenyl)ureido]diphenylsulfone; a thiourea compound, such as N,N′-di-m-chlorophenylthiourea; an organic compounds having —SO₂NH bond in a molecule, such as p-cumylphenyl N-(p-toluenesulfonyl)carbamoylate ester, p-benzyloxyphenyl N-(p-toluenesulfonyl)carbamoylate ester, N-[2-(3-phenylureido)phenyl]benzenesulfonamide, or N-(o-toluoyl)-p-toluenesulfoamide; and an inorganic acid material, such as activated clay, attapulgite, colloidal silica, or aluminum silicate.

Other examples of the color developer include: a urea urethane derivative represented by the following Formula (1), such as 4,4′-bis[(4-methyl-3-phenoxycarbonylaminophenyl)ureido]diphenylsulfone, 4,4′-bis[(2-methyl-5-phenoxycarbonylaminophenyl)ureido]diphenylsulfone, or 4-(2-methyl-3-phenoxycarbonylaminophenyl)ureido-4′-(4-methyl-5-phenoxycarbonylaminophenyl)ureidodiphenylsulfone; and a diphenylsulfone derivative represented by the following Formula (2).

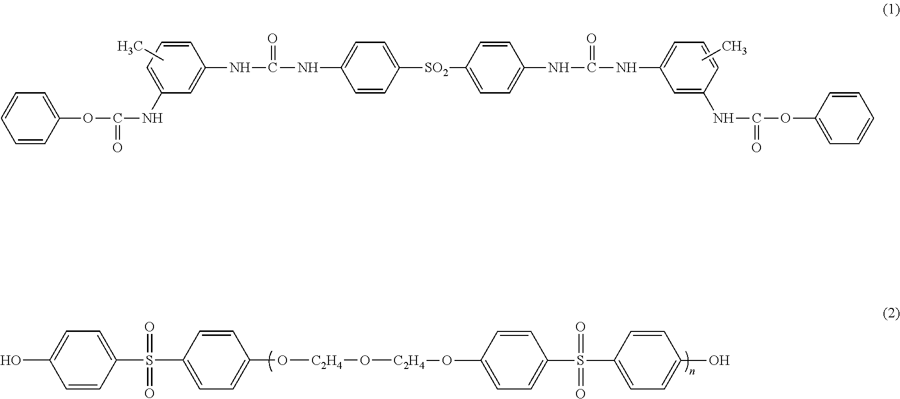

(In the formula, n represents an integer of 1 to 6.)

Obviously, the color developer is not limited to these examples. Optionally, two or more compounds can also be used in combination.

The content of the color developer is not particularly limited and may be adjusted depending on the leuco dye to be used. In general, the content of the color developer is preferably 0.5 parts by mass or more, more preferably 0.8 parts by mass or more, still more preferably 1 part by mass or more, still more preferably 1.2 parts by mass or more, and still more preferably 1.5 parts by mass or more with respect to 1 part by mass of the leuco dye. In addition, the content of the color developer is preferably 10 parts by mass or less, more preferably 5 parts by mass or less, still more preferably 4 parts by mass or less, and still more preferably 3.5 parts by mass or less with respect to 1 part by mass of the leuco dye. By adjusting the content to 0.5 parts by mass or more, the recording performance can be improved. On the other hand, by adjusting the content to 10 parts by mass or less, background coloring in a high-temperature environment can be effectively suppressed.

In the embodiment, in order to further improve mainly preservability of a color image in the heat-sensitive recording layer, the heat-sensitive recording layer may further contain a preservability improver. As the preservability improver, at least one kind selected from the following group can be used, the group consisting of: a phenolic compound such as 1,1,3-tris(2-methyl-4-hydroxy-5-cyclohexylphenyl)butane, 1,1,3-tris(2-methyl-4-hydroxy-5-tert-butylphenyl)butane, 1,1-bis(2-methyl-4-hydroxy-5-tert-butylphenyl)butane, 4,4′-[1,4-phenylenebis(1-methylethylidene)]bisphenol, or 4,4′-[1,3-phenylenebis(1-methylethylidene)]bisphenol; an epoxy compound, such as 4-benzyloxyphenyl-4′-(2-methyl-2,3-epoxypropyloxy)phenylsulfone, 4-(2-methyl-1,2-epoxyethyl)diphenylsulfone, or 4-(2-ethyl-1,2-epoxyethyl)diphenylsulfone; and an isocyanuric acid compound such as 1,3,5-tris(2,6-dimethylbenzyl-3-hydroxy-4-tert-butyl)isocyanuric acid. Obviously, the preservability improver is not limited to these examples. Optionally, two or more compounds can also be used in combination.

When the preservability improver is used, the amount thereof used is not particularly limited as long as it is effective for improving the preservability. Typically, the amount of the preservability improver used is preferably about 1 mass % to 30 mass % and more preferably about 5 mass % to 20 mass % with respect to the total solid content of the heat-sensitive recording layer.

The heat-sensitive recording layer in the embodiment may also contain a sensitizer. As a result, the recording sensitivity can be improved. Examples of the sensitizer include stearic acid amide, methoxycarbonyl-N-stearic acid benzamide, N-benzoyl stearic acid amide, N-eicosanoic acid amide, ethylenebisstearic acid amide, behenic acid amide, methylenebisstearic acid amide, N-methylol stearic acid amide, dibenzyl terephthalate, dimethyl terephthalate, dioctyl terephthalate, diphenylsulfone, benzyl p-benzyloxybenzoate, phenyl 1-hydroxy-2-naphthoate, 2-naphthyl benzyl ether, m-terphenyl, p-benzylbiphenyl, oxalic acid-di-p-chlorobenzyl ester, oxalic acid-di-p-methylbenzyl ester, oxalic acid-dibenzyl ester, p-tolyl biphenyl ether, di(p-methoxyphenoxyethyl)ether, 1,2-di(3-methylphenoxy)ethane, 1,2-di(4-methylphenoxy)ethane, 1,2-di(4-methoxyphenoxy)ethane, 1,2-di(4-chlorophenoxy)ethane, 1,2-diphenoxyethane, 1-(4-methoxyphenoxy)-2-(3-methylphenoxy)ethane, p-methylthiophenylbenzylether, 1,4-di(phenylthio)butane, p-acetotoluidide, p-acetophenetidide, N-acetoacetyl-p-toluidine, 1,2-diphenoxymethylbenzene, di(β-biphenylethoxy)benzene, p-di(vinyloxyethoxy)benzene, 1-isopropylphenyl-2-phenylethane, di-o-chlorobenzyl adipate, 1,2-bis(3,4-dimethylphenyl)ethane, 1,3-bis(2-naphthoxy)propane, diphenyl, and benzophenone. These sensitizers can be used in combination within a range where the effects of the embodiment do not deteriorate. The content ratio of the sensitizer is not particularly limited as long as it is effective for sensitization. Typically, the content ratio of the sensitizer is preferably about 2 to 40 mass % and more preferably about 5 to 25 mass % with respect to the total solid content of the heat-sensitive recording layer.

In order to improve the whiteness of the heat-sensitive recording layer and the uniformity of an image, the heat-sensitive recording layer can contain a fine particle pigment having high whiteness and an average particle size of 10 μm or less. Examples of the fine particle pigment that can be used include: an inorganic pigment, such as calcium carbonate, magnesium carbonate, kaolin, clay, talc, calcined clay, silica, diatomaceous earth, synthetic aluminum silicate, zinc oxide, titanium oxide, aluminum hydroxide, barium sulfate, surface-treated calcium carbonate, or surface-treated silica; and an organic pigment, such as urea-formalin resin, a styrene-methacrylic acid copolymer resin, or a polystyrene resin. The content ratio of the pigment is preferably an amount that does not decrease the color optical density, that is, 50 mass % or less with respect to the total solid content of the heat-sensitive color development layer.

As other components forming the heat-sensitive recording layer, an adhesive is used, and optionally a cross-linking agent, a wax, a metal soap, a water resistance agent, a dispersant, a colored dye, a fluorescent dye, and the like can be further used.

As the adhesive used for the heat-sensitive recording layer-forming coating material, for example, a water-soluble or a water-dispersible aqueous adhesive can be used. Examples of the water-soluble adhesive include: polyvinyl alcohol; a modified polyvinyl alcohol, such as carboxy-modified polyvinyl alcohol, acetoacetyl-modified polyvinyl alcohol, diacetone-modified polyvinyl alcohol, or silicon-modified polyvinyl alcohol; starch or a derivative thereof; a cellulose derivative, such as methoxy cellulose, carboxymethyl cellulose, hydroxymethyl cellulose, hydroxyethyl cellulose, hydroxypropyl methyl cellulose, methyl cellulose, or ethyl cellulose; and sodium polyacrylate, polyvinylpyrrolidone, polyamide, a diisobutylene-maleic anhydride copolymer salt, a styrene-acrylic acid copolymer salt, a styrene-maleic anhydride copolymer salt, an ethylene-maleic anhydride copolymer salt, an acrylic acid amide-acrylate copolymer, an acrylic acid amide-acrylate-methacrylic acid copolymer, polyacrylamide, sodium alginate, gelatin, casein, and gum arabic. Examples of the water-dispersible adhesive include a latex, such as polyvinyl acetate, polyurethane, a styrene-butadiene copolymer, a styrene-butadiene-acrylonitrile copolymer, an acrylonitrile-butadiene copolymer, polyacrylic acid, a polyacrylate, a vinyl chloride-vinyl acetate copolymer, polybutyl methacrylate, an ethylene-vinyl acetate copolymer, silylated urethane, an acrylic silicon composite, an acrylic silicon urethane composite, an urea resin, a melamine resin, an amide resin, or a polyurethane resin. These water-dispersible adhesives can be used alone or in combination of two or more kinds. At least one adhesive is mixed in an amount of preferably about 5 mass % to 50 mass % and more preferably about 10 mass % to 40 mass % with respect to the total solid content of the heat-sensitive recording layer.

The heat-sensitive recording layer can contain a cross-linking agent that cures the adhesive in the heat-sensitive recording layer or other layers. As a result, the water resistance of the heat-sensitive recording layer can be improved. Examples of the cross-linking agent include: an aldehyde compound such as glyoxal; a polyamine compound such as polyethyleneimine; an epoxy compound, a polyamide resin, a melamine resin, a glyoxylic acid salt, a dimethylolurea compound, an aziridine compound, and a block isocyanate compound; an inorganic compound, such as ammonium persulfate, ferric chloride, magnesium chloride, soda tetraborate, or potassium tetraborate; and boric acid, boric acid triester, a boron polymer, a hydrazide compound, and a glyoxylic acid salt. These cross-linking agents may be used alone or in combination of two or more kinds. The amount of the cross-linking agent used is preferably in a range of about 1 part by mass to 10 parts by mass with respect to 100 parts by mass of the total solid content of the heat-sensitive recording layer. As a result, the water resistance of the heat-sensitive recording layer can be improved.

Examples of the wax include: a wax, such as paraffin wax, carnauba wax, microcrystalline wax, polyolefin wax, or polyethylene wax; a higher fatty acid amide, such as stearic acid amide or ethylene-bis-stearic acid amide; and a higher fatty acid ester or a derivatives thereof.

Examples of metal soaps include a higher fatty acid polyvalent metal salt, such as zinc stearate, aluminum stearate, calcium stearate, or zinc oleate. In addition, optionally, various auxiliary agents such as an oil repellent, a defoaming agent, or a viscosity control agent can be further added to the heat-sensitive recording layer within a range where the effects of the embodiment do not deteriorate.

The heat-sensitive recording layer is formed as follows. In general, the leuco dye and color developer and optionally the sensitizer and the preservability improver are dispersed together or separately in water as a dispersion medium using various stirrers or wet pulverizers, such as a ball mill, a co-ball mill, an attritor, or a vertical or horizontal sand mill together with a water-soluble synthetic polymer compound, such as polyacrylamide, polyvinyl pyrrolidone, polyvinyl alcohol, methyl cellulose, or a styrene-maleic anhydride copolymer salt and a surfactant such that a dispersion liquid having an average particle size of 2 μm or less is obtained. The obtained dispersion liquid is mixed with optionally a pigment, an adhesive, an auxiliary agent, and the like to prepare the heat-sensitive recording layer-forming coating material, the heat-sensitive recording layer-forming coating material is applied and dried to form the heat-sensitive recording layer on the undercoat layer. The coating amount of the heat-sensitive recording layer is not particularly limited and is preferably about 1 g/m² to 12 g/m², more preferably about 2 g/m² to 10 g/m², still more preferably about 2.5 g/m² to 8 g/m², and still more preferably about 3 g/m² to 5.5 g/m² in terms of the coating amount after drying. The heat-sensitive recording layer can be formed as two or more separate layers, and the compositions and the coating amounts of the respective layers may be the same as or different from each other.

[Protective Layer]

In the heat-sensitive recording material, optionally, a protective layer can be provided on the heat-sensitive recording layer. It is preferable that the protective layer should contain a pigment and an adhesive. Further, in order to suppress sticking to a thermal head, it is preferable that the protective layer should contain a lubricant, such as polyolefin wax or zinc stearate, and the protective layer can also contain an ultraviolet absorber. In addition, by providing the protective layer that is glossy, the added value of the product can also be increased.

The adhesive in the protective layer is not particularly limited, and a water-soluble or water-dispersible aqueous adhesive can be used. The adhesive can be appropriately selected from those that can be used in the heat-sensitive recording layer.

In general, the protective layer is formed on the heat-sensitive recording layer by mixing the pigment and the adhesive and optionally an auxiliary agent and the like in water as a dispersion medium to prepare a protective layer-forming coating material and applying and drying the protective layer-forming coating material. The coating amount of the protective layer-forming coating material is not particularly limited and is preferably about 0.3 g/m² to 15 g/m², more preferably about 0.3 g/m² to 10 g/m², still more preferably about 0.5 g/m² to 8 g/m², still more preferably about 1 g/m² to 8 g/m², and still more preferably about 1 g/m² to 5 g/m² in terms of the dry weight. The protective layer can be formed as two or more separate layers, and the compositions and the coating amounts of the respective layers may be the same as or different from each other.

[Other Layers]

In the embodiment, in order to improve the added value of the heat-sensitive recording material, by further performing processes, a heat-sensitive recording material having a higher function can be obtained. For example, by applying a pressure sensitive adhesive, a remoistening adhesive, a delayed tack pressure sensitive adhesive, or the like to a back surface of the heat-sensitive recording material, adhesive paper, remoistening adhesive paper, or delayed tack paper can be obtained. In addition, recording paper capable of two-sided recording can also be formed by imparting a function as heat transfer paper, ink jet recording paper, carbon-free paper, electrostatic recording paper, xerography paper, or the like to the back surface of the heat-sensitive recording material. Obviously, a two-sided heat-sensitive recording material can also be formed. In addition, a back layer can also be provided to inhibit permeation of oil and a plasticizer from the back surface of the heat-sensitive recording material or to control curling or suppress static charge.

By applying a release layer containing silicone to the protective layer and applying a pressure sensitive adhesive to the back surface, the heat-sensitive recording material can also be formed as a linerless label that does not require release paper.

[Heat-Sensitive Recording Material]

The heat-sensitive recording material can be manufactured by forming the above-described layers on the support. As a method of forming each of the layers on the support, any existing coating method, such as an air knife method, a blade method, a gravure method, a roll coater method, a spray method, a dip method, a bar method, a curtain method, a slot-die method, a slide die method, or an extrusion method may be used. In addition, each of the coating materials may be applied and dried to form a single layer, or the same coating material may be applied to form two or more separate layers. Further, simultaneous multilayer coating of simultaneously applying two or more layers may be performed. In addition, in any process after completing the formation of each of the layers or the formation of all of the layers, a smoothing process can be performed using an existing method using a super calender, a soft calender, or the like.

It is preferable that the undercoat layer should be a layer formed using a curtain coating method. As a result, a layer having a uniform thickness can be formed such that the effect obtained by the hollow particles can be fully exhibited, the recording sensitivity can be improved, and barrier properties to oil, a plasticizer, alcohol, or the like can be improved. The curtain coating method is a method in which a coating material flows down to freely fall without contact with an intermediate layer, and a well-known method, such as a slide curtain method, a couple curtain method, or a twin curtain method can be adopted without any particular limitation.

B. Heat-Sensitive Recording Material (B)

The heat-sensitive recording material (B) includes an undercoat layer and a heat-sensitive recording layer on a support in this order, the undercoat layer containing hollow particles, and the heat-sensitive recording layer containing a leuco dye and a color developer. An average particle size of the hollow particles is 3 μm to 20 μm and the heat-sensitive recording layer further contains an inorganic layered compound.

[Support]

As the support according to the embodiment, the support described above in “Support” of “A. Heat-sensitive Recording Material (A)” can be adopted.

[Undercoat Layer]

In the heat-sensitive recording material according to the embodiment, the undercoat layer is provided between the support and the heat-sensitive recording layer. The undercoat layer contains hollow particles having an average particle size of 3 μm to 20 μm.

(Hollow Particles)

From the viewpoint of improving cushioning properties, it is preferable that the hollow particles should be formed of an organic resin. The undercoat layer that has high thermal insulation properties by containing the hollow particles suppresses diffusion of heat applied to the heat-sensitive recording layer and can improve sensitivity of the heat-sensitive recording material.

Hollow particles formed of an organic resin can be classified into a foaming type and a non-foaming type depending on manufacturing methods. Regarding these two types, in general, the average particle size and the hollow ratio of the foaming type hollow particles are greater than those of the non-foaming type hollow particles. Therefore, with the foaming type hollow particles, higher sensitivity and image quality can be obtained as compared to the non-foaming type hollow particles.

Hereinafter, a representative method of manufacturing the foaming type hollow particles will be described.

First, particles in which volatile liquid is sealed in a resin are prepared, and the resin is softened during heating while vaporizing and expanding the liquid in the particles. As a result, the hollow particles can be manufactured.

Regarding the foaming type hollow particles, the liquid in the particles are heated to expand in the process of manufacturing such that the hollow ratio increases and high thermal insulation properties can be obtained. Therefore, the sensitivity of the heat-sensitive recording material can be improved, and the recording density can be improved. The improvement of the sensitivity is important when a halftone region where thermal energy applied to the heat-sensitive recording layer is low is colored. In addition, when the heat-sensitive recording layer is formed through the undercoat layer having high thermal insulation properties, diffusion of heat applied to the heat-sensitive recording layer is suppressed, and thus, image uniformity becomes excellent, and image quality can also be improved. Therefore, in the embodiment, it is preferable to use the foaming type hollow particle that is suitable for improvement of the thermal insulation properties of the undercoat layer.

Examples of the resin that can be used for the foaming type hollow particles include a thermoplastic resin, for example, a styrene-acrylic resin, a polystyrene resin, an acrylic resin, a polyethylene resin, a polypropylene resin, a polyacetal resin, a chlorinated polyether resin, a polyvinyl chloride resin, a polyvinylidene chloride resin, an acrylic resin (for example, an acrylic resin containing acrylonitrile as a component), a styrene resin, or a copolymer resin, such as a vinylidene chloride resin, mainly formed of polyvinylidene chloride and acrylonitrile. As gas in the foaming type hollow particles, for example, propane, butane, isobutane, or air can be generally used.

As the resin used for the hollow particles, an acrylonitrile resin or a copolymer resin mainly formed of polyvinylidene chloride and acrylonitrile is preferable from the viewpoint of the strength for maintaining the shape of foamed particles in the various resins described above.

On the other hand, with regard to the non-foaming type hollow particles, in general, the average particle size is small, and the hollow ratio is also low. Therefore, in order to obtain excellent sensitivity and image quality, it is preferable to increase the content of the hollow particles in the undercoat layer.

In a method of manufacturing the non-foaming type hollow particles, a seed is polymerized in a solution, another resin is polymerized to cover the seed, and the seed in the resin is removed by swelling and dissolution. As a result, voids are formed in the resin. In order to remove the seed in the resin by swelling and dissolution, an alkaline aqueous solution or the like is used. By performing an alkali swelling process on core-shell particles in which core particles having alkali swellability are covered with a shell layer having no alkali swellability, the non-foaming type hollow particles having a relatively large average particle size can also be obtained.

Examples of a monomer that is suitable for the method of manufacturing the non-foaming type hollow particles include a vinyl monomer, such as a styrene monomer, an acrylic monomer, or an acrylonitrile monomer. Examples of the styrene monomer include styrene, methylstyrene, dimethylstyrene, trimethylstyrene, ethylstyrene, diethylstyrene, triethylstyrene, propylstyrene, butylstyrene, chlorstyrene, and t-butylstyrene. Examples of the acrylic monomer include methyl acrylate, ethyl acrylate, n-butyl acrylate, isobutyl acrylate, 2-ethylhexyl acrylate, cyclohexyl acrylate, methyl methacrylate, ethyl methacrylate, n-butyl methacrylate, isobutyl methacrylate, 2-ethylhexyl methacrylate, and cyclohexyl methacrylate. Examples of the acrylonitrile monomer include acrylonitrile and methacrylonitrile. Examples of other vinyl monomers include dimethyl maleate, dimethyl fumarate, maleic anhydride, N-methylmaleimide, and N-phenylmaleimide.

Among the various monomers described above, from the viewpoint of easy manufacturing, a combination of a styrene monomer and an acrylic monomer is preferable, and a combination of a styrene monomer and a (meth)acrylate is more preferable. That is, it is preferable that the hollow particles should be formed of a styrene-acrylic resin, and it is more preferable that the hollow particles are formed of a styrene-(meth)acrylate copolymer resin.

The average particle size of the hollow particles is 3 μm to 20 μm and preferably 3.5 μm to 20 μm. Here, the average particle size signifies a diameter at which the volume of large particle size particles is the same as that of small particle size particles when particles are divided into two kinds based on the particle size, that is, the average particle size signifies a median size as a particle size corresponding to 50 vol % frequency, and is represented by D50.

When the average particle size of the hollow particles is 3 μm or more, the cushioning properties of the undercoat layer are improved. Therefore, adhesion of the heat-sensitive recording material with a thermal head during printing is improved, and a heat-sensitive recording material having high image quality can be obtained. This high image quality can bring about improvement of recording density in a halftone region that is colored with lower energy than the energy for providing the maximum recording density (Dmax).

On the other hand, when the average particle size of the hollow particles is 20 μm or less, the smoothness of the undercoat layer is improved. Therefore, the heat-sensitive recording layer that is provided through the undercoat layer can be made uniform, and the heat-sensitive recording material in which the formation of white spots in an image is not likely to occur can be obtained.

The average particle size (D50) of the hollow particles can be measured using a laser diffraction particle size analyzer. In addition, the average particle size (D50) may be obtained by measuring the particle sizes from particle images (SEM images) using an electron microscope and obtaining the average values of 10 particle sizes.

The hollow ratio of the hollow particles is not particularly limited and is preferably 65% or more, more preferably 70% or more, and still more preferably 80% or more. The hollow ratio is a value obtained from the following expression (d³/D³)×100. In the expression, d represents the inner diameter of the hollow particles, and D represents the outer diameter of the hollow particles. The hollow ratio can be calculated using the measurement method described above in “A. Heat-sensitive Recording Material (A)”.

The content ratio of the hollow particles with respect to the total solid content of the undercoat layer is preferably 5 mass % to 90 mass %, more preferably 5 mass % to 70 mass %, still more preferably 5 mass % to 50 mass %, and still more preferably 10 mass % to 50 mass %. When the content ratio of the hollow particles is 5 mass % or more, the thermal insulation properties of the undercoat layer can be improved. On the other hand, when the content ratio of the hollow particles is 90 mass % or less, a problem is not likely to occur in terms of coating properties or the like, a uniform undercoat layer is likely to be formed, and the recording density can be improved.

It is preferable that an oil-absorbing pigment should be added to the undercoat layer. By adding the oil-absorbing pigment to the undercoat layer, printing failures such as sticking or remaining of residues on a thermal head can be effectively suppressed. Examples of the oil-absorbing pigment include fired kaolin. The content ratio of the oil-absorbing pigment is preferably 2 mass % to 80 mass % and more preferably 30 mass % to 70 mass % with respect to the total solid content of the undercoat layer.

(Adhesive)

As the adhesive used for the undercoat layer, for example, a water-soluble polymer is used. Examples of the water-soluble polymer include: polyvinyl alcohol or a derivative thereof; starch or a derivative thereof; a cellulose derivative, such as carboxymethyl cellulose, hydroxymethyl cellulose, hydroxyethyl cellulose, hydroxypropyl cellulose, methyl cellulose, or ethyl cellulose; and sodium polyacrylate, polyvinyl pyrrolidone, casein, gelatin, or a derivative thereof.

Examples of an adhesive other than the water-soluble polymer include an emulsion, such as an acrylamide-acrylate copolymer, an acrylamide-acrylate-methacrylate copolymer, a styrene-maleic anhydride copolymer, an isobutylene-maleic anhydride copolymer, polyvinyl acetate, polyurethane, polyacrylic acid, a polyacrylate, a vinyl chloride-vinyl acetate copolymer, polybutyl methacrylate, or an ethylene-vinyl acetate copolymer, a styrene-butadiene copolymer, and a styrene-butadiene-acrylic copolymer. These resins can be used as a latex dispersed in water in many cases.

The undercoat layer is formed on the support, in general, by mixing the hollow particles and the adhesive and optionally the oil-absorbing pigment, such as fired kaolin, an auxiliary agent, and the like in water as a medium to prepare the undercoat layer-forming coating material, applying the undercoat layer-forming coating material to the support, and performing drying. The coating amount of the undercoat layer-forming coating material is not particularly limited and is preferably about 2 g/m² to 20 g/m² and more preferably about 2 g/m² to 12 g/m² in terms of dry weight.

[Heat-Sensitive Recording Layer]

The heat-sensitive recording layer according to the embodiment can contain various well-known colorless or pale color leuco dyes and color developers (developer).

As the leuco dye, the leuco dye described above in “Heat-sensitive recording layer” of “A. Heat-sensitive Recording Material (A)” can be adopted.

The content ratio of the leuco dye is not particularly limited and is preferably about 3 mass % to 30 mass %, more preferably about 5 mass % to 25 mass %, and still more preferably 7 mass % to 20 mass % with respect to the total solid content of the heat-sensitive recording layer. By adjusting the content ratio to 3 mass % or more, the color developability is improved, and the print density can be improved. By adjusting the content ratio to 30 mass % or less, the heat resistance can be improved.

As the color developer, the color developer described above in “Heat-sensitive recording layer” of “A. Heat-sensitive Recording Material (A)” can be adopted.

The content of the color developer is not particularly limited and may be adjusted depending on the leuco dye to be used. In general, the content of the color developer is preferably 0.5 parts by mass or more, more preferably 0.8 parts by mass or more, still more preferably 1 part by mass or more, still more preferably 1.2 parts by mass or more, and still more preferably 1.5 parts by mass or more with respect to 1 part by mass of the leuco dye. In addition, the content of the color developer is preferably 10 parts by mass or less, more preferably 5 parts by mass or less, still more preferably 4 parts by mass or less, and still more preferably 3.5 parts by mass or less with respect to 1 part by mass of the leuco dye. By adjusting the content to 0.5 parts by mass or more, the recording performance can be improved. On the other hand, by adjusting the content to 10 parts by mass or less, background coloring in a high-temperature environment can be effectively suppressed.

The heat-sensitive recording layer according to the embodiment further contains an inorganic layered compound. As a result, in the embodiment, a decrease in recording density can be suppressed, although in general, when the undercoat layer contains the hollow particles having a relatively large average particle size, the maximum recording density may decrease.

Specific examples of the inorganic layered compound include a mica group represented by Formula A(B,C)₂₋₅D₄O₁₀(OH,F,O)₂ [where A represents any of K, Na, or Ca, B and C represent any of Fe(II), Fe(III), Mn, Al, Mg, or V, D represents Si or Al], talc represented by 3MgO-4SiO·H₂O, sepiolite represented by Formula (H₂O)₄(OH)₄Mg₈Si₁₂O₃₀·6 to 8H₂O, taeniolite, montmorillonite, saponite, hectorite, and zirconium phosphate.

Examples of the mica group include, natural mica, muscovite, paragonite, phlogopite, biotite, and lepidolite. In addition, examples of the synthetic mica include: non-swelling mica, such as potassium fluorphlogopite KMg₃(AlSi₃O₁₀)F₂ or potassium-tetrasilic mica KMg_{2.5}(Si₄O₁₀)F₂; and water-swellable mica, such as Na tetrasilylic mica NaMg_{2.5}(Si₄O₁₀)F₂, Na or Li taeniolite (Na,Li)Mg₂Li(Si₄O₁₀)F₂, or montmorillonite-based Na or Li hectorite (Na or Li)_{1/8}Mg_{2/5}Li_{1/8}(Si₄O₁₀)F₂. Further, synthetic smectite is also useful. Among these inorganic layered compounds, the fluorine-based water-swellable synthetic mica as a synthetic inorganic layered compound is particularly useful.

An aspect ratio of the inorganic layered compound is preferably 20 or more, more preferably 100 or more, and still more preferably 200 or more. Here, the aspect ratio signifies a ratio of the thickness to the diameter of the particles of the inorganic layered compound.

The average particle size of the inorganic layered compound is preferably 0.3 μm to 20 μm and more preferably 3 μm to 15 μm. The average thickness of the inorganic layered compound is preferably 0.1 μm or less, more preferably 0.05 μm or less, and still more preferably 0.01 μm or less. The average particle size of the inorganic layered compound can be measured using a laser diffraction particle size analyzer. In addition, the average thickness of the inorganic layered compound can be measured by crystal structure analysis using X-ray diffraction.

The content ratio of the inorganic layered compound is preferably about 0.1 to 8 mass %, more preferably about 1 to 7 mass %, and preferably about 2 to 7 mass % with respect to the total solid content of the heat-sensitive recording layer. By adjusting the content ratio to 0.1 mass % or more, the maximum recording density can be improved. On the other hand, by adjusting the content ratio to 8 mass % or less, an increase in the viscosity of the heat-sensitive recording layer-forming coating liquid is suppressed, a uniform layer having no defects is formed, and image quality can be improved.

The heat-sensitive recording layer according to the embodiment is provided by simultaneous multilayer coating of applying the heat-sensitive recording layer-forming coating liquid containing the inorganic layered compound and the adhesive and a protective layer-forming coating liquid described below using a curtain coating method and performing drying. Optionally, the heat-sensitive recording layer can be formed as two or more separate layers, and the compositions and the coating amounts of the respective layers can be made different.

Specific examples of the inorganic layered compound include a mica group represented by Formula A(B,C)₂₋₅D₄O₁₀(OH,F,O)₂ [where A represents any of K, Na, or Ca, B and C represent any of Fe(II), Fe(III), Mn, Al, Mg, or V, D represents Si or Al], talc represented by 3MgO·4SiO·H₂O, sepiolite represented by Formula (H₂O)₄(OH)₄Mg₈Si₁₂O₃₀·6 to 8H₂O, taeniolite, montmorillonite, saponite, hectorite, and zirconium phosphate.

With regard to the mica group, examples of natural mica include: muscovite, paragonite, phlogopite, biotite, and lepidolite. In addition, examples of the synthetic mica include: non-swelling mica, such as potassium fluorphlogopite KMg₃(AlSi₃O₁₀)F₂ or potassium-tetrasilic mica KMg_{2.5}(Si₄O₁₀)F₂; and water-swellable mica, such as Na tetrasilylic mica NaMg_{2.5}(Si₄O₁₀)F₂, Na or Li taeniolite (Na,Li)Mg₂Li(Si₄O₁₀)F₂, or montmorillonite-based Na or Li hectorite (Na or Li)_{1/8}Mg_{2/5}Li_{1/8}(Si₄O₁₀)F₂. Further, synthetic smectite is also useful. Among these inorganic layered compounds, the fluorine-based water-swellable synthetic mica as a synthetic inorganic layered compound is particularly useful.

An aspect ratio of the inorganic layered compound is preferably 20 or more, more preferably 100 or more, and still more preferably 200 or more. Here, the aspect ratio signifies a ratio of the thickness to the diameter of the particles of the inorganic layered compound.

The average particle size of the inorganic layered compound is preferably 0.3 μm to 20 μm, more preferably 0.5 μm to 10 μm, and still more preferably 1 μm to 5 μm. The average thickness of the inorganic layered compound is preferably 0.1 μm or less, more preferably 0.05 μm or less, and still more preferably 0.01 μm or less.

The content of the inorganic layered compound is preferably about 0.1 to 8 mass %, more preferably about 0.5 to 6 mass %, and preferably about 2 to 5 mass % with respect to the total solid content of the heat-sensitive recording layer. By adjusting the content to be in this range, an increase in the viscosity of the heat-sensitive recording layer-forming coating liquid is suppressed, and the curtain coating suitability is improved. Further, the strength of the coating film does not decrease, and when the heat-sensitive recording layer and the protective layer are provided by simultaneous multilayer coating using a curtain coating method, an effect of suppressing interlayer mixing can be significantly improved.

In the embodiment, the heat-sensitive recording layer can further contain materials, such as a preservability improver, a sensitizer, or a fine particle pigment. As these materials, the materials described above in “Heat-sensitive recording layer” of “A. Heat-sensitive Recording Material (A)” can be adopted.

When the preservability improver is contained, the amount thereof used is not particularly limited as long as it is effective for improving the preservability. Typically, the amount of the preservability improver used is preferably about 1 mass % to 30 mass % and more preferably about 5 mass % to 20 mass % with respect to the total solid content of the heat-sensitive recording layer.

When the sensitizer is contained, the content ratio of the sensitizer is not particularly limited as long as it is effective for sensitization. Typically, the content ratio of the sensitizer is preferably about 2 to 40 mass % and more preferably about 5 to 25 mass % with respect to the total solid content of the heat-sensitive recording layer.

When the heat-sensitive recording layer contains the fine particle pigment, it is preferable that precipitated calcium carbonate as the fine particle pigment should be used in a range of 1 part by mass to 5 parts by mass with respect to 1 part by mass of the inorganic layered compound. As a result, bulkiness is imparted to the heat-sensitive recording layer, and the effect of cushioning properties can be fully exhibited.

As other components forming the heat-sensitive recording layer, an adhesive is used, and optionally a cross-linking agent, a wax, a metal soap, a water resistance agent, a dispersant, a colored dye, a fluorescent dye, and the like can be further used. As these materials, the materials described above in “Heat-sensitive recording layer” of “A. Heat-sensitive Recording Material (A)” can be adopted.

The adhesive is mixed in a range of preferably about 5 mass % to 50 mass % and more preferably about 10 mass % to 40 mass % with respect to the total solid content of the heat-sensitive recording layer.

When the cross-linking agent is used, the amount of the cross-linking agent used is preferably in a range of about 1 part by mass to 10 parts by mass with respect to 100 parts by mass of the total solid content of the heat-sensitive recording layer. As a result, the water resistance of the heat-sensitive recording layer can be improved.

The heat-sensitive recording layer is formed as follows. In general, the leuco dye and color developer and optionally the sensitizer and the preservability improver are dispersed together or separately in water as a dispersion medium using various stirrers or wet pulverizers, such as a ball mill, a co-ball mill, an attritor, or a vertical or horizontal sand mill together with a water-soluble synthetic polymer compound, such as polyacrylamide, polyvinyl pyrrolidone, polyvinyl alcohol, methyl cellulose, or a styrene-maleic anhydride copolymer salt and a surfactant such that a dispersion liquid having an average particle size of 2 μm or less is obtained. The obtained dispersion liquid is mixed with optionally a pigment, an adhesive, an auxiliary agent, and the like to prepare the heat-sensitive recording layer-forming coating material, the heat-sensitive recording layer-forming coating material is applied and dried to form the heat-sensitive recording layer on the undercoat layer. The coating amount of the heat-sensitive recording layer is not particularly limited and is preferably about 1 g/m² to 12 g/m², more preferably about 2 g/m² to 10 g/m², still more preferably about 2.5 g/m² to 8 g/m², and still more preferably about 3 g/m² to 5.5 g/m² in terms of the coating amount after drying. The heat-sensitive recording layer can be formed as two or more separate layers, and the compositions and the coating amounts of the respective layers may be the same as or different from each other.

[Protective Layer]

In the heat-sensitive recording material, optionally, a protective layer can be provided on the heat-sensitive recording layer. As the protective layer, the protective layer described above in “Protective Layer” of “A. Heat-sensitive Recording Material (A)” can be adopted.

[Other Layers]

In the embodiment, in order to improve the added value of the heat-sensitive recording material, by further performing processes, a heat-sensitive recording material having a higher function can be obtained. As the other layers, the other layers described above in “Protective Layer” of “A. Heat-sensitive Recording Material (A)” can be adopted.

[Heat-Sensitive Recording Material]

The heat-sensitive recording material can be manufactured by forming the above-described layers on the support. As the method of forming each of the layers, the method described in “Heat-sensitive Recording Material” of “A. Heat-sensitive Recording Material (A)” can be adopted.

It is preferable that the heat-sensitive recording layer should be a layer formed using a curtain coating method. As a result, a layer having a uniform thickness can be formed, the effect obtained by the hollow particles can be fully exhibited, and the recording sensitivity can be improved. The curtain coating method is a method in which a coating material flows down to freely fall without contact, and a well-known method, such as a slide curtain method, a couple curtain method, or a twin curtain method can be adopted without any particular limitation.

C. Heat-Sensitive Recording Material (C)

The heat-sensitive recording material according to the embodiment includes: an undercoat layer that is formed on one surface of a support; and a heat-sensitive recording layer that is formed on the undercoat layer. The heat-sensitive recording layer is a layer where a portion to which heat is applied is colored to display characters, a design, or the like. The undercoat layer is a layer having, for example, a function of improving the fixing of the heat-sensitive recording layer and improving thermal insulation properties for suppressing diffusion of the heat.

Hereinafter, the materials forming the heat-sensitive recording material will be described.

[Support]

As the support, according to the embodiment, the support described above in “Support” of “A. Heat-sensitive Recording Material (A)” can be adopted.

[Undercoat Layer]

The undercoat layer is provided between the support and the heat-sensitive recording layer. The undercoat layer contains hollow particles and an adhesive. It is preferable that the undercoat layer should further contain thickener.

(Hollow Particles)

The hollow particles formed of an organic resin improve the thermal insulation properties of the undercoat layer by being contained in the undercoat layer. The undercoat layer that has high thermal insulation properties suppresses diffusion of heat applied to the heat-sensitive recording layer and can improve sensitivity of the heat-sensitive recording material.

Hollow particles formed of an organic resin can be classified into a foaming type and a non-foaming type depending on manufacturing methods. In these two types, the foaming type hollow particles have properties suitable for improving the thermal insulation properties of the undercoat layer.

Hereinafter, a representative method of manufacturing the foaming type hollow particles will be described.

First, particles in which volatile liquid is sealed in a resin are prepared. Next, the resin is softened during heating while vaporizing and expanding the liquid in the particles. As a result, the hollow particles can be manufactured.

The foaming type hollow particles have a high hollow ratio, and thus high thermal insulation properties can be obtained. Therefore, the sensitivity of the heat-sensitive paper can be improved, and the recording density can be improved. The improvement of the sensitivity is important when a halftone region where thermal energy applied to the heat-sensitive recording layer is low is colored.

In addition, when the heat-sensitive recording layer is formed through the undercoat layer having high thermal insulation properties, diffusion of heat applied to the heat-sensitive recording layer can be suppressed. As a result, blurring of an image can be suppressed, and image quality can be improved.

Therefore, in the embodiment, the foaming type hollow particles that are excellent in improving the thermal insulation properties of the undercoat layer are used.

Examples of the resin that can be used for the foaming type hollow particles include a thermoplastic resin, for example, a styrene-acrylic resin, a polystyrene resin, an acrylic resin, a polyethylene resin, a polypropylene resin, a polyacetal resin, a chlorinated polyether resin, a polyvinyl chloride resin, a polyvinylidene chloride resin, an acrylic resin (for example, an acrylic resin containing acrylonitrile as a component), a styrene resin, or a copolymer resin, such as a vinylidene chloride resin, mainly formed of polyvinylidene chloride and acrylonitrile. As gas in the foaming type hollow particles, for example, propane, butane, isobutane, or air can be generally used.

As the resin used for the hollow particles, an acrylonitrile resin or a copolymer resin mainly formed of polyvinylidene chloride and acrylonitrile is preferable from the viewpoint of the strength for maintaining the shape of foamed particles in the various resins described above.

The undercoat layer according to the embodiment contains, as the hollow particles, at least two kinds of particles including large particle size hollow particles (hereinafter, also referred to as “first hollow particles”) and small particle size hollow particles (hereinafter, also referred to as “second hollow particles”), the two kinds particles having different maximum particle sizes.

The maximum particle size of the first hollow particles is 10 μm to 80 μm, preferably 12 μm to 65 μm, and more preferably 10 μm to 50 μm. The maximum particle size is a maximum particle size in the distribution and is also represented by D100.

When the maximum particle size of the first hollow particles is less than 10 μm, the cushioning properties of the undercoat layer deteriorate. Therefore, adhesion of the heat-sensitive paper to a thermal head during printing deteriorates, and it is difficult to obtain high image quality. On the other hand, when the maximum particle size of the first hollow particles is more than 80 μm, the smoothness of the undercoat layer deteriorates. Therefore, it is difficult to make the heat-sensitive recording layer provided on the undercoat layer uniform, and the color optical density decreases.

On the other hand, the maximum particle size of the second hollow particles is preferably 1 to 7 μm and more preferably 2 to 5 μm.

The maximum particle size (D100) of the hollow particles can be measured using a laser diffraction particle size analyzer. In addition, the maximum particle size (D100) of the hollow particles can also be actually measured using an electron microscope.

The maximum particle size of the second hollow particles is less than that of the first hollow particles. By using both of the first hollow particles and the second hollow particles, gaps between the first hollow particles in the undercoat layer can be filled with the second hollow particles. By filling the gaps between the first hollow particles with the second hollow particles, the thermal insulation properties of the undercoat layer can be further improved, and the heat-sensitive recording material that has high image quality and is excellent in halftone print density can be obtained. Regarding a mixing ratio between the first hollow particles and the second hollow particles, preferably 0.1 parts by mass to 10 parts by mass and more preferably 0.5 parts by mass to 5 parts by mass of the second hollow particles are contained with respect to 1 part by mass of the first hollow particles.

When particles of powder are divided into two kinds based on the particle size, a diameter at which the volume of large particle size particles is the same as that of small particle size particles, that is, a particle size corresponding to 50 vol % frequency is a median size or an average particle size. The median size is also represented by D50.

The median size (D50) of the first hollow particles is 7.5 μm to 25 μm and preferably 7.5 μm to 15 μm. When the median size (D50) of the first hollow particles is less than 7.5 μm, the cushioning properties of the undercoat layer deteriorate. Therefore, adhesion of the heat-sensitive paper to a thermal head during printing deteriorates, and it is difficult to obtain high image quality. On the other hand, when the median size (D50) of the first hollow particles is more than 15 μm, the smoothness of the undercoat layer deteriorates. Therefore, it is difficult to make the heat-sensitive recording layer provided on the undercoat layer uniform, and the color optical density decreases.

The median size (D50) of the second hollow particles is 0.7 μm to 6 μm, preferably 0.7 μm to 4 μm, and more preferably 0.7 μm to 3 μm.

The median size (D50) of the hollow particles can be measured using a laser diffraction particle size analyzer. In addition, the median size (D50) of the hollow particles can also be actually measured using an electron microscope.

A ratio D100/D50 of the maximum particle size (D100) to the median size (D50) is an index representing the degree of a particle size distribution. The D100/D50 of the first hollow particles is 1.8 to 10.0, preferably 1.8 to 5.0, and more preferably 1.8 to 3.0.

When D100/D50 of the first hollow particles is less than 1.8, the particle size distribution is very sharp, the manufacturing may be difficult to perform. On the other hand, when D100/D50 of the first hollow particles is more than 10.0, the maximum particle size is excessively large. Therefore, the smoothness of the undercoat layer deteriorates, and the color optical density may decrease.

The hollow ratio of the first hollow particles is preferably 80% to 98% and more preferably 90% to 98%. When the hollow ratio of the hollow particles is 80% or more, high thermal insulation properties can be imparted to the undercoat layer containing the hollow particles. On the other hand, when the hollow ratio of the hollow particles is 98% or less, the strength of a film covering a hollow portion is improved. As a result, hollow particles that do not collapse during the formation of the undercoat layer can be obtained.

On the other hand, the hollow ratio of the second hollow particles is preferably less than 80% and more preferably less than 60%. When the hollow ratio of the second hollow particles is less than 80%, there is an advantageous effect in that the manufacturing of the particles is easy and inexpensive irrespective of whether the hollow particles are of a foaming type or a non-foaming type. The hollow ratio can be calculated using the measurement method described above in “A. Heat-sensitive Recording Material (A)”.

The content of a mixture of the hollow particles containing the first hollow particles and the second hollow particles is 5 mass % to 75 mass % and preferably 7 mass % to 50 mass % with respect to the total solid content of the undercoat layer.

When the content of the mixture of the hollow particles is less than 5 mass %, it is difficult to improve thermal insulation properties. On the other hand, when the content of the mixture of the hollow particles is more than 75 mass %, a problem is likely to occur in terms of coating properties and the like.

In addition, the content of the first hollow particles is 5 mass % to 40 mass % and preferably 5 mass % to 30 mass % with respect to the total solid content of the undercoat layer.

(Thickener)

It is preferable that the thickener should be contained in an undercoat layer-forming coating liquid. When the undercoat layer-forming coating liquid contains the thickener, uneven distribution of the hollow particles in the undercoat layer-forming coating liquid can be suppressed. As the thickener, for example, various well-known materials, such as cellulose or a derivative thereof, a polymer polysaccharide, a polyacrylic acid modified product, sodium alginate, or a maleic anhydride copolymer can be appropriately used. Among these, the cellulose derivative, such as carboxymethyl cellulose (CMC) or the polymer polysaccharide is suitable as the thickener.

The maximum particle size of the first hollow particles is large. Therefore, the buoyancy is large, and the first hollow particles tend to aggregate upward in a liquid having low viscosity. When the cellulose derivative or the polymer polysaccharide is used as the thickener of the undercoat layer-forming coating liquid, the first hollow particles are not likely to float upward in the undercoat layer-forming coating liquid, and the dispersibility of the first hollow particles is improved. When the dispersibility of the first hollow particles is improved, the smoothness of the undercoat layer is improved. Therefore, the heat-sensitive recording layer that is provided through the undercoat layer can be made uniform, and the formation of white spots in an image can be suppressed.

(Adhesive)

The adhesive can be appropriately selected from adhesives used for the heat-sensitive recording layer described below. Examples of the adhesive include oxidized starch, a starch-vinyl acetate graft copolymer, carboxymethylated cellulose, polyvinyl alcohol, and latex. Among these, latex is preferable.

The latex is not particularly limited, and examples thereof include a water-insoluble polymer such as polyvinyl acetate, polyurethane, a styrene-butadiene copolymer, a styrene-butadiene-acrylonitrile copolymer, an acrylonitrile-butadiene copolymer, polyacrylic acid, a polyacrylate, a vinyl chloride-vinyl acetate copolymer, polybutyl methacrylate, an ethylene-vinyl acetate copolymer, silylated urethane, an acrylic silicon composite, an acrylic silicon urethane composite, an urea resin, a melamine resin, an amide resin, or a polyurethane resin. Among the latexes, it is preferable that at least a styrene-butadiene copolymer (styrene-butadiene latex) should be contained.

In addition, the glass transition temperature (Tg) of the styrene-butadiene latex is preferably −10° C. or lower and more preferably −30° C. or lower. As Tg of the styrene-butadiene latex decreases, an effect of further improving image quality can be obtained.

The undercoat layer is formed on the support, in general, by mixing and stirring the hollow particles and the adhesive and optionally the oil-absorbing pigment, an auxiliary agent, and the like in water as a medium to prepare the undercoat layer-forming coating liquid, applying the undercoat layer-forming coating liquid to the support, and performing drying. The coating amount of the undercoat layer-forming coating liquid is not particularly limited and is preferably 2.0 g/m² to 10 g/m² and more preferably 2.5 g/m² to 7 g/m² in terms of the coating amount after drying.

[Heat-Sensitive Recording Layer]

(Dye Precursor)

In general, the heat-sensitive recording layer contains a dye precursor and a color developer (developer). Representative examples of the dye precursor include a colorless or pale color leuco dye. Examples of the leuco dye include a triphenylmethane compound, a fluoran compound, and a diphenylmethane compound. The leuco dye can be appropriately selected and used. In addition, examples of the leuco dye include dyes having color tones, such as red, vermilion, magenta, blue, cyan, yellow, green, or black, and the leuco dye can be appropriately selected and used.

As the leuco dye, the leuco dye described above in “Heat-sensitive recording layer” of “A. Heat-sensitive Recording Material (A)” can be adopted. Among these, 3-di(n-butyl)amino-6-methyl-7-anilinofluoran, 3-di(n-pentyl)amino-6-methyl-7-anilinofluoran, and 3-(N-ethyl-N-isoamylamino)-6-methyl-7-anilinofluoran have excellent recording sensitivity and print preservability and thus are preferably used.

The content of the dye precursor (leuco dye) is preferably 5 mass % to 30 mass %, more preferably 7 mass % to 30 mass %, and still more preferably 7 mass % to 25 mass % with respect to the total solid content of the heat-sensitive recording layer. When the content of the dye precursor is 5 mass % or more, the color optical density is improved. When the content of the dye precursor is 30 mass % or less, heat resistance is improved. In addition, the content of the dye precursor per unit area in the heat-sensitive recording layer is preferably 0.2 g/m² to 2.0 g/m² and more preferably 0.4 g/m² to 1.5 g/m². The content of the dye precursor per unit area can be measured by high-performance liquid chromatography or the like.

(Color Developer)

As the color developer, the color developer described above in “Heat-sensitive recording layer” of “A. Heat-sensitive Recording Material (A)” can be adopted.

The content of the color developer is not particularly limited and may be adjusted depending on the leuco dye to be used. In general, the content of the color developer is preferably 0.5 parts by mass or more, more preferably 0.8 parts by mass or more, still more preferably 1 part by mass or more, still more preferably 1.2 parts by mass or more, and still more preferably 1.5 parts by mass or more with respect to 1 part by mass of the leuco dye. In addition, the content of the color developer is preferably 10 parts by mass or less, more preferably 5 parts by mass or less, still more preferably 4 parts by mass or less, and still more preferably 3.5 parts by mass or less with respect to 1 part by mass of the leuco dye. By adjusting the content of the color developer to 0.5 parts by mass or more, the recording performance can be improved. On the other hand, by adjusting the content of the color developer to 10 parts by mass or less, background coloring in a high-temperature environment can be effectively suppressed.

In the embodiment, the heat-sensitive recording layer can further contain materials, such as a preservability improver, a sensitizer, or a fine particle pigment. As these materials, the materials described above in “Heat-sensitive recording layer” of “A. Heat-sensitive Recording Material (A)” can be adopted.

As other components forming the heat-sensitive recording layer, an adhesive is used, and optionally materials, such as a cross-linking agent, a wax, a metal soap, a water resistance agent, a dispersant, a colored dye, or a fluorescent dye can be further used. As these materials, the materials described above in “Heat-sensitive recording layer” of “A. Heat-sensitive Recording Material (A)” can be adopted.

In addition, optionally, various auxiliary agents such as an oil repellent, a defoaming agent, or a viscosity control agent can be further added to the heat-sensitive recording layer within a range where the effects of the embodiment do not deteriorate.

The heat-sensitive recording layer-forming coating liquid is prepared, for example, using a dispersion liquid obtained by dispersing fine particles of the dye precursor (leuco dye) and the color developer, the adhesive, the preservability improver, the sensitizer, and the like together or separately in water as a dispersion medium. The heat-sensitive recording layer-forming coating liquid is applied to the support such that the coating amount is preferably 2 g/m² to 12 g/m², more preferably 2 g/m² to 8 g/m², and still more preferably 2 g/m² to 7 g/m² in terms of dry weight.

[Protective Layer]

A protective layer can be further provided on the heat-sensitive recording layer. As the protective layer, the protective layer described above in “Protective Layer” of “A. Heat-sensitive Recording Material (A)” can be adopted.

[Other Layers]

In the embodiment, in order to improve the added value of the heat-sensitive recording material, by further performing processes, a heat-sensitive recording material having a higher function can be obtained. As the other layers, the other layers described above in “Protective Layer” of “A. Heat-sensitive Recording Material (A)” can be adopted.

[Heat-Sensitive Recording Material]

The heat-sensitive recording material can be manufactured by forming the above-described layers on the support. As the method of forming each of the layers, the method described in “Heat-sensitive Recording Material” of “A. Heat-sensitive Recording Material (A)” can be adopted.

It is preferable that the undercoat layer should be a layer formed using a curtain coating method. As a result, a layer having a uniform thickness can be formed such that the effect obtained by the hollow particles can be fully exhibited, the recording sensitivity can be improved, and barrier properties to oil, a plasticizer, alcohol, or the like can be improved. The curtain coating method is a method in which a coating material flows down to freely fall without contact with an intermediate layer, and a well-known method, such as a slide curtain method, a couple curtain method, or a twin curtain method can be adopted without any particular limitation.

### EXAMPLES

The present invention will be described in more detail using Examples, but the present invention is not limited thereto. Unless specified otherwise, “part” and “%” represent “part(s) by mass” and “mass %”, respectively.

As the average particle size of hollow particles, an inorganic layered compound, latex particles of a styrene-butadiene copolymer, and a pigment, the median size (D50) was measured using a laser diffraction particle size analyzer SALD2200 (manufactured by Shimadzu Corporation).

### A. Heat-Sensitive Recording Material (A)

### Example A1

### (1) Preparation of Undercoat Layer-Forming Coating Material

Further, 59 parts of fired kaolin (trade name: ANSILEX 93, manufactured by BASF SE), 41.7 parts of a styrene-butadiene copolymer (trade name: SR-104, manufactured by Nippon A&L Inc., solid content concentration: 48%, particle size: 160 nm, glass transition temperature: 3° C.), 4 parts of a 25% aqueous solution of oxidized starch (trade name: OJI ACE A, manufactured by Oji Cornstarch Co., Ltd.), 100 parts of hollow particles A (foaming type, average particle size: 9 μm, maximum particle size: 20 μm, solid content concentration: 20%), and 75.5 parts of water were mixed and stirred to prepare a composition, and an undercoat layer-forming coating material was obtained.

### (2) Preparation of Leuco Dye Dispersion Liquid (A Liquid)

Further, 40 parts of 3-di-(n-butyl)amino-6-methyl-7-anilinofluoran, 40 parts of a 10% aqueous solution of polyvinyl alcohol (polymerization degree: 500, saponification degree: 88%), and 20 parts of water were mixed and were pulverized using a sand mill (manufactured by IMEX Co., Ltd., a sand grinder) such that the median size obtained by a laser diffraction particle size analyzer SALD2200 (manufactured by Shimadzu Corporation) was 0.5 μm. As a result, a leuco dye dispersion liquid (A liquid) was obtained.

### (3) Preparation of Color Developer Dispersion Liquid (B Liquid)

Further, 40 parts of 4-hydroxy-4′-isopropoxydiphenylsulfone (manufactured by Nippon Soda Co., Ltd., D8), 40 parts of a 10% aqueous solution of polyvinyl alcohol (polymerization degree: 500, saponification degree: 88%), and 20 parts of water were mixed, and were pulverized using a sand mill (manufactured by IMEX Co., Ltd., a sand grinder) such that the median size obtained by a laser diffraction particle size analyzer SALD2200 (manufactured by Shimadzu Corporation) was 0.7 μm. As a result, a color developer dispersion liquid (B liquid) was obtained.

### (4) Preparation of Sensitizer Dispersion Liquid (C Liquid)

Further, 40 parts of oxalic acid-di-p-methylbenzyl ester (trade name: HS-3520, manufactured by DIC Corporation), 40 parts of a 10% aqueous solution of polyvinyl alcohol (polymerization degree: 500, saponification degree: 88%), and 20 parts of water were mixed, and were pulverized using a sand mill (manufactured by IMEX Co., Ltd., a sand grinder) such that the median size obtained by a laser diffraction particle size analyzer SALD2200 (manufactured by Shimadzu Corporation) was 1.0 μm. As a result, a sensitizer dispersion liquid (C liquid) was obtained.

### (5) Preparation of Heat-Sensitive Recording Layer-Forming Coating Material

Further, 29.5 parts of the A liquid, 59.1 parts of the B liquid, 45.4 parts of the C liquid, 20 parts of a 5% aqueous solution of hydroxymethyl cellulose, 45 parts of a 10% aqueous solution of completely saponified polyvinyl alcohol (polymerization degree: 1000, saponification degree: 99 mol %), and 9.4 parts of a butadiene copolymer latex (trade name: L-1571, manufactured by Asahi Kasei Corporation, solid content concentration: 48%), 17.1 parts of precipitated calcium carbonate (trade name: Brilliant-15, manufactured by Shiraishi Kogyo Kaisha, Ltd.), 11.7 parts of paraffin wax (trade name: HYDRIN L-700, manufactured by Chukyo Yushi Co., Ltd., solid content concentration: 30%), 2 parts of adipic acid dihydrazide (manufactured by Otsuka Chemical Co., Ltd.), and 120 parts of water, were mixed and stirred to obtain a composition, and thus a heat-sensitive recording layer-forming coating material was obtained.

### (6) Preparation of Protective Layer-Forming Coating Material

Further, 300 parts of a 12% aqueous solution of acetoacetyl modified polyvinyl alcohol (trade name: GOHSENX Z-200, saponification degree: 99.4 mol %, average polymerization degree: 1000, modification degree: 5 mol %, manufactured by Nippon Synthetic Chemical Industry Co., Ltd.), 19 parts of kaolin (trade name: HYDRAGLOSS90, manufactured by KaMin LLC.), 35 parts of aluminum hydroxide (trade name: HEIDI WRIGHT H-42M, manufactured by Showa Denko K.K.), 4 parts of silica (trade name: MIZUKASIL P-527, manufactured by Mizusawa Industrial Chemicals, Ltd.), 2.5 parts of polyethylene wax (trade name: CHEMIPEARL W-400, manufactured by Mitsui Chemicals, Inc., solid content concentration: 40%), and 114.5 parts of water were mixed and stirred to obtain a composition, and thus a protective layer-forming coating material was obtained.

### (7) Preparation of Heat-sensitive Recording Material

The undercoat layer-forming coating material, the heat-sensitive recording layer-forming coating material, and the protective layer-forming coating material were applied to a single surface of high-quality paper having a basis weight of 60 g/m² such that the coating amounts after drying thereof were 6.0 g/m², 4.0 g/m², and 2.0 g/m², respectively, and were dried to sequentially form an undercoat layer, a heat-sensitive recording layer, and a protective layer. The surfaces of the layers were smoothed using a super calender to obtain a heat-sensitive recording material. The undercoat layer was formed by applying the undercoat layer-forming coating material using a curtain coating method and performing drying.

### Example A2

A heat-sensitive recording material was obtained using the same method as that of Example A1, except that during the preparation of the undercoat layer-forming coating material according to Example A1, 41.7 parts of a styrene-butadiene copolymer (trade name: SR-107, manufactured by Nippon A&L Inc., solid content concentration: 48%, particle size: 170 nm, glass transition temperature: −15° C.) was used instead of 41.7 parts of a styrene-butadiene copolymer (trade name: SR-104, manufactured by Nippon A&L Inc., solid content concentration: 48%, particle size: 160 nm, glass transition temperature: 3° C.).

### Example A3

A heat-sensitive recording material was obtained using the same method as that of Example A1, except that during the preparation of the undercoat layer-forming coating material according to Example A1, 41.7 parts of a styrene-butadiene copolymer (trade name: SR-103, manufactured by Nippon A&L Inc., solid content concentration: 48%, particle size: 220 nm, glass transition temperature: 7° C.) was used instead of 41.7 parts of a styrene-butadiene copolymer (trade name: SR-104, manufactured by Nippon A&L Inc., solid content concentration: 48%, particle size: 160 nm, glass transition temperature: 3° C.).

### Example A4

A heat-sensitive recording material was obtained using the same method as that of Example A1, except that during the preparation of the undercoat layer-forming coating material according to Example A1, 6.7 parts of a 15% aqueous solution of polyvinyl alcohol (trade name: PVA 11-98, manufactured by Kuraray Co., Ltd.) was used instead of 4 parts of a 25% aqueous solution of oxidized starch (trade name: OJI ACE A, manufactured by Oji Cornstarch Co., Ltd.).

### Example A5

A heat-sensitive recording material was obtained using the same method as that of Example A1, except that during the preparation of the undercoat layer-forming coating material according to Example A1, 1 part of carboxymethyl cellulose (trade name: CELLOGEN 7A, manufactured by DKS Co., Ltd.) was used instead of 4 parts of a 25% aqueous solution of oxidized starch (trade name: OJI ACE A, manufactured by Oji Cornstarch Co., Ltd.).

### Example A6

A heat-sensitive recording material was obtained using the same method as that of Example A1, except that during the preparation of the undercoat layer-forming coating material according to Example A1, the amount of fired kaolin (trade name: ANSILEX 93, manufactured by BASF SE) was changed from 59 parts to 19 parts and the amount of the hollow particles A (foaming type, average particle size: 9 μm, maximum particle size: 20 μm, solid content concentration: 20%) was changed from 100 parts to 300 parts.

### Comparative Example A1

A heat-sensitive recording material was obtained using the same method as that of Example A1, except that during the preparation of the undercoat layer-forming coating material according to Example A1, 75.5 parts of hollow particles B (non-foaming type, trade name: ROPAQUE SN-1055, manufactured by Dow Chemical Company, average particle size: 1 μm, maximum particle size: 2 μm, solid content concentration: 26.5%) was used instead of 100 parts of hollow particles A (foaming type, average particle size: 9 μm, maximum particle size: 20 μm, solid content concentration: 20%).

### Comparative Example A2

A heat-sensitive recording material was obtained using the same method as that of Example A1, except that during the preparation of the undercoat layer-forming coating material according to Example 1, 133 parts of hollow particles C (foaming type, average particle size: 20 μm, maximum particle size: 40 μm, solid content concentration: 15%) was used instead of 100 parts of hollow particles A (foaming type, average particle size: 9 μm, maximum particle size: 20 μm, solid content concentration: 20%).

### Comparative Example A3

A heat-sensitive recording material was obtained using the same method as that of Example A1, except that during the preparation of the undercoat layer-forming coating material according to Example A1, 4 parts of a 25% aqueous solution of oxidized starch (trade name: OJI ACE A, manufactured by Oji Cornstarch Co., Ltd.) was not used.

The heat-sensitive recording material obtained as described above was evaluated as follows. The results are as shown in Table 1.

[Recording Density]

Using a heat-sensitive recording evaluation tester (trade name: TH-PMD, manufactured by Ohkura-Denki), recording was performed on each of the heat-sensitive recording materials in a halftone energy range with printing energy: 0.16 mJ/dot, and the printed portion was measured in a visual mode of a Macbeth densitometer (RD-914, manufactured by Macbeth Corporation). As the numerical value increases, the print density becomes higher, and the sensitivity becomes higher.

[Print Image Quality]

Using a label printer (trade name: L-2000, manufactured by Ishida Co., Ltd.), a barcode was recorded, the recording image quality was observed by visual inspection and evaluated based on the following criteria.
A: the formation of white spots regarding image quality or the thickening of the barcode did not occur, and there were no problems
B: the formation of white spots regarding image quality or the thickening of the barcode did not substantially occur, and there were no problems in practice
C: the formation of white spots in an image or the thickening of the barcode occurred, and there were problems in practice

TABLE 1

| | Recording | Print Image |
|---|---|---|
| | Density | Quality |
| Example A1 | 1.40 | B |
| Example A2 | 1.36 | A |
| Example A3 | 1.38 | A |
| Example A4 | 1.41 | B |
| Example A5 | 1.43 | B |
| Example A6 | 1.31 | B |
| Comparative | 1.42 | C |
| Example A1 | | |
| Comparative | 1.25 | B |
| Example A2 | | |
| Comparative | 1.43 | C |
| Example A3 | | |

### B. Heat-Sensitive Recording Material (B)

### Example B1

### (1) Preparation of Undercoat Layer-Forming Coating Material

Further, 59 parts of fired kaolin (trade name: ANSILEX 93, manufactured by BASF SE), 133.3 parts of hollow particles A (trade name: A-380, manufactured by Sansuisha Co., Ltd., non-foaming type hollow particles formed of a styrene-acrylic resin, average particle size: 3.5 μm, hollow ratio: 78%, solid content concentration: 15%), 41.7 parts of a styrene-butadiene copolymer (trade name: L-1571, solid content concentration: 48%, manufactured by Asahi Kasei Corporation), 4 parts of a 25% aqueous solution of oxidized starch (trade name: OJI ACE A, manufactured by Oji Cornstarch Co., Ltd.), and 75.5 parts of water were mixed and stirred to obtain a composition, and thus an undercoat layer-forming coating material was obtained.

### (2) Preparation of Leuco Dye Dispersion Liquid (A Liquid)

Further, 40 parts of 3-di-(n-butyl)amino-6-methyl-7-anilinofluoran, 40 parts of a 10% aqueous solution of polyvinyl alcohol (polymerization degree: 500, saponification degree: 88%), and 20 parts of water were mixed and were pulverized using a sand mill (manufactured by IMEX Co., Ltd., a sand grinder) such that the median size obtained by a laser diffraction particle size analyzer SALD2200 (manufactured by Shimadzu Corporation) was 0.5 μm. As a result, a leuco dye dispersion liquid (A liquid) was obtained.

### (3) Preparation of Color Developer Dispersion Liquid (B Liquid)

Further, 40 parts of 4-hydroxy-4′-isopropoxydiphenylsulfone (trade name: D-8, manufactured by Nippon Soda Co., Ltd.), 40 parts of a 10% aqueous solution of polyvinyl alcohol (polymerization degree: 500, saponification degree: 88%), and 20 parts of water were mixed, and were pulverized using a sand mill (manufactured by IMEX Co., Ltd., a sand grinder) such that the median size obtained by a laser diffraction particle size analyzer SALD2200 (manufactured by Shimadzu Corporation) was 0.7 μm. As a result, a color developer dispersion liquid (B liquid) was obtained.

### (4) Preparation of Sensitizer Dispersion Liquid (C Liquid)

Further, 40 parts of oxalic acid-di-p-methylbenzyl ester (trade name: HS-3520, manufactured by DIC Corporation), 40 parts of a 10% aqueous solution of polyvinyl alcohol (polymerization degree: 500, saponification degree: 88%), and 20 parts of water were mixed, and were pulverized using a sand mill (manufactured by IMEX Co., Ltd., a sand grinder) such that the median size obtained by a laser diffraction particle size analyzer SALD2200 (manufactured by Shimadzu Corporation) was 1.0 μm. As a result, a sensitizer dispersion liquid (C liquid) was obtained.

### (5) Preparation of Heat-Sensitive Recording Layer-Forming Coating Material

Further, 29.5 parts of the A liquid, 59.1 parts of the B liquid, 45.4 parts of the C liquid, 20 parts of a 5% aqueous solution of hydroxymethyl cellulose, 45 parts of a 10% aqueous solution of completely saponified polyvinyl alcohol (polymerization degree: 1000, saponification degree: 99 mol %), and 9.4 parts of a butadiene copolymer latex (trade name: L-1571, manufactured by Asahi Kasei Corporation, solid content concentration: 48%), 12.1 parts of precipitated calcium carbonate (trade name: Brilliant-15, manufactured by Shiraishi Kogyo Kaisha, Ltd.), 11.7 parts of paraffin wax (trade name: HYDRIN L-700, manufactured by Chukyo Yushi Co., Ltd., solid content concentration: 30%), 2 parts of adipic acid dihydrazide (manufactured by Otsuka Chemical Co., Ltd.), 83.3 parts of a 6% aqueous dispersion of water-swellable synthetic mica (trade name: NTO-5, average particle size: 11 μm, manufactured by Topy Industries, Ltd.), and 50 parts of water, were mixed and stirred to obtain a composition, and thus a heat-sensitive recording layer-forming coating material was obtained.

### (6) Preparation of Protective Layer-Forming Coating Material

Further, 300 parts of a 12% aqueous solution of acetoacetyl modified polyvinyl alcohol (trade name: GOHSENX Z-200, saponification degree: 99.4 mol %, average polymerization degree: 1000, modification degree: 5 mol %, manufactured by Nippon Synthetic Chemical Industry Co., Ltd.), 19 parts of kaolin (trade name: HYDRAGLOSS90, manufactured by KaMin LLC.), 35 parts of aluminum hydroxide (trade name: HEIDI WRIGHT H-42M, manufactured by Showa Denko K.K.), 4 parts of silica (trade name: MIZUKASIL P-527, manufactured by Mizusawa Industrial Chemicals, Ltd.), 2.5 parts of polyethylene wax (trade name: CHEMIPEARL W-400, manufactured by Mitsui Chemicals, Inc., solid content concentration: 40%), and 114.5 parts of water were mixed and stirred to obtain a composition, and thus a protective layer-forming coating material was obtained.

### (7) Preparation of Heat-Sensitive Recording Material

The undercoat layer-forming coating material, the heat-sensitive recording layer-forming coating material, and the protective layer-forming coating material were applied to a single surface of high-quality paper having a basis weight of 60 g/m² such that the coating amounts after drying thereof were 6.0 g/m², 4.0 g/m², and 2.0 g/m², respectively, and were dried to sequentially form an undercoat layer, a heat-sensitive recording layer, and a protective layer. The surfaces of the layers were smoothed using a super calender to obtain a heat-sensitive recording material. The heat-sensitive recording layer was formed by applying the heat-sensitive recording layer-forming coating material using a curtain coating method, and then performing drying.

### Example B2

A heat-sensitive recording material was obtained using the same method as that of Example B1, except that during the preparation of the undercoat layer-forming coating material according to Example B1, 133.3 parts of hollow particles B (trade name: EXPANCEL 461WE20d36, foaming type hollow particles manufactured by Akzo Nobel N.V., average particle size: 20 μm, solid content concentration: 15%) was used instead of 133.3 parts of hollow particles A (trade name: A-380, manufactured by Sansuisha Co., Ltd., non-foaming type hollow particles formed of a styrene-acrylic resin, average particle size: 3.5 μm, hollow ratio: 78%, solid content concentration: 15%).

### Example B3

A heat-sensitive recording material was obtained using the same method as that of Example B2, except that during the preparation of the heat-sensitive recording layer-forming coating material according to Example B2, 100 parts of a 5% aqueous dispersion of water-swellable synthetic mica (trade name: NHT sol B, average particle size: 3.4 μm) was used instead of 83.3 parts of a 6% aqueous dispersion of water-swellable mica (trade name: NTO-5, average particle size: 11 μm, manufactured by Topy Industries, Ltd.).

### Example B4

A heat-sensitive recording material was obtained using the same method as that of Example B2, except that during the preparation of the heat-sensitive recording layer-forming coating material according to Example B2, 100 parts of a 5% aqueous dispersion of hectorite (trade name: LAPONITE RD, average particle size: 13 μm, manufactured by BYK Corporation) was used instead of 83.3 parts of a 6% aqueous dispersion of water-swellable synthetic mica (trade name: NTO-5, average particle size: 11 μm, manufactured by Topy Industries, Ltd.).

### Comparative Example B1

A heat-sensitive recording material was obtained using the same method as that of Example B1, except that during the preparation of the undercoat layer-forming coating material according to Example B1, 75.5 parts of hollow particles C (trade name: ROPAQUE SN-1055, manufactured by Dow Chemical Company, non-foaming type hollow particles formed of a styrene-acrylic resin, average particle size: 1.0 μm, hollow ratio: 55%, solid content concentration: 26.5%) was used instead of 133.3 parts of hollow particles A (trade name: A-380, manufactured by Sansuisha Co., Ltd., non-foaming type hollow particles formed of a styrene-acrylic resin, average particle size: 3.5 μm, hollow ratio: 78%, solid content concentration: 15%).

### Comparative Example B2

A heat-sensitive recording material was obtained using the same method as that of Example B1, except that during the preparation of the heat-sensitive recording layer-forming coating material according to Example B1, 83.3 parts of a 6% aqueous dispersion of water-swellable synthetic mica (trade name: NTO-5, average particle size: 11 μm, manufactured by Topy Industries, Ltd.) was not used.

### Comparative Example B3

A heat-sensitive recording material was obtained using the same method as that of Example B1, except that during the preparation of the heat-sensitive recording layer-forming coating material according to Example B1, 5 parts of engineered kaolin (trade name: CONTOUR 1500, average particle size: 3.6 μm) was used instead of 83.3 parts of a 6% aqueous dispersion of water-swellable synthetic mica (trade name: NTO-5, average particle size: 11 μm, manufactured by Topy Industries, Ltd.).

The heat-sensitive recording materials obtained as described above were evaluated as follows. The results are as shown in Table 2.

[Maximum Recording Density]

Using a heat-sensitive recording evaluation tester (trade name: TH-PMD, manufactured by Ohkura-Denki), recording was performed on each of the heat-sensitive recording materials with printing energy: 0.24 mJ/dot, and the printed portion was measured in a visual mode of a Macbeth densitometer (RD-914, manufactured by Macbeth Corporation.). As the numerical value increases, the print density becomes higher.

[Print Image Quality]

Using a label printer (trade name: L-2000, manufactured by Ishida Co., Ltd.), a barcode was recorded, the recording image quality was observed by visual inspection and evaluated based on the following criteria.
A: the formation of white spots regarding image quality or the thickening of the barcode did not occur, and there were no problems
B: the formation of white spots regarding image quality or the thickening of the barcode did not substantially occur, and there were no problems in practice
C: the formation of white spots regarding image quality or the thickening of the barcode occurred, and there were problems in practice

TABLE 2

| | Maximum Recording | Print Image |
|---|---|---|
| | Density | Quality |
| Example B1 | 1.50 | B |
| Example B2 | 1.45 | A |
| Example B3 | 1.42 | A |
| Example B4 | 1.40 | A |
| Comparative | 1.50 | C |
| Example B1 | | |
| Comparative | 1.23 | B |
| Example B2 | | |
| Comparative | 1.22 | B |
| Example B3 | | |

### C. Heat-Sensitive Recording Material (C)

Materials used in Examples and Comparative Examples are as follows.
(1) Hollow Particles
(i) Hollow particles A: trade name=EXPANCEL 461WE20d36, hollow particles manufactured by Akzo Nobel N.V., median size (D50)=20 μm, maximum particle size (D100)=80 μm, hollow ratio=95%, the ratio of the particles having a particle size of 2 μm or less=0 vol %, solid content concentration=15.0%
(ii) Hollow particles B: median size (D50)=12 μm, maximum particle size (D100)=45 μm, hollow ratio=94%, the ratio of the particles having a particle size of 2 μm or less=0 vol %, solid content concentration=15.0%
(iii) Hollow particles C: median size (D50)=11 μm, maximum particle size (D100)=23 μm, hollow ratio=93%, the ratio of the particles having a particle size of 2 μm or less=0 vol %, solid content concentration=15.0%
(iv) Hollow particles D: median size (D50)=8.1 μm, maximum particle size (D100)=20 μm, hollow ratio=90%, the ratio of the particles having a particle size of 2 μm or less=0 vol %, solid content concentration=15.0%
(v) Hollow particles E: median size (D50)=7.5 μm, maximum particle size (D100)=15 μm, hollow ratio=85%, the ratio of the particles having a particle size of 2 μm or less=0 vol %, solid content concentration=15.0%
(vi) Hollow particles F: median size (D50)=12 μm, maximum particle size (D100)=124 μm, hollow ratio=94%, the ratio of the particles having a particle size of 2 μm or less=0 vol %, solid content concentration=15.0%
(vii) Hollow particles G: median size (D50)=6.2 μm, maximum particle size (D100)=15 μm, hollow ratio=77%, the ratio of the particles having a particle size of 2 μm or less=0 vol %, solid content concentration=15.0%
(viii) Hollow particles H: trade name=A-380, hollow particles manufactured by Sansuisha Co., Ltd., median size (D50)=3.8 μm, maximum particle size (D100)=6.5 μm, hollow ratio=78%, the ratio of the particles having a particle size of 2.0 μm or less=1.5 vol %, solid content concentration=13.0%
(ix) Hollow particles I: median size (D50)=5.0 μm, maximum particle size (D100)=13.5 μm, hollow ratio=90%, the ratio of the particles having a particle size of 2 μm or less=0.2 vol %, solid content concentration=15.0%
(x) Hollow particles J: trade name=ROPAQUE SN-1055, hollow particles manufactured by Dow Chemical Company, median size (D50)=1.0 μm, maximum particle size (D100)=2.0 μm, hollow ratio=55%, the ratio of the particles having a particle size of 2.0 μm or less=100 vol %, solid content concentration=26.5%
(2) Latex
(i) Latex A: a styrene-butadiene latex development article (Tg: −10° C., average particle size: 190 nm, solid content concentration: 48%)
(ii) Latex B: a styrene-butadiene latex development article (Tg: −35° C., average particle size: 300 nm, solid content concentration: 48%)
(iii) Latex C: a styrene-butadiene latex (trade name: L-1571, manufactured by Asahi Kasei Corporation, Tg=−3° C., average particle size: 190 nm, solid content concentration: 48%)

### Example C1

### (1) Preparation of Undercoat Layer-Forming Coating Liquid

Further, 120.0 parts of the hollow particles A, 135.8 parts of the hollow particles J, 18.0 parts of fired kaolin (trade name: ANSILEX 93, manufactured by BASF SE), 25 parts of the latex A, 3.0 parts of carboxymethyl cellulose (trade name: CELLOGEN AG gum, manufactured by DKS Co., Ltd.), and 75.0 parts of water were mixed and stirred to obtain an undercoat layer-forming coating liquid.

### (2) Preparation of Leuco Dye Dispersion Liquid (A Liquid)

Further, 40 parts of 3-di-(n-butyl)amino-6-methyl-7-anilinofluoran, 40 parts of a 10% aqueous solution of polyvinyl alcohol (polymerization degree: 500, saponification degree: 88%), and 20 parts of water were mixed and were pulverized using a sand mill (manufactured by IMEX Co., Ltd., a sand grinder) using a laser diffraction particle size analyzer SALD2200 (manufactured by Shimadzu Corporation) such that the median size was 0.5 μm. As a result, a leuco dye dispersion liquid (A liquid) was obtained.

### (3) Preparation of Color Developer Dispersion Liquid (B Liquid)

Further, 40 parts of 4-hydroxy-4′-isopropoxydiphenylsulfone (manufactured by Nippon Soda Co., Ltd., D-8), 40 parts of a 10% aqueous solution of polyvinyl alcohol (polymerization degree: 500, saponification degree: 88%), and 20 parts of water were mixed, and were pulverized using a sand mill (manufactured by IMEX Co., Ltd., a sand grinder) such that the median size obtained by a laser diffraction particle size analyzer SALD2200 (manufactured by Shimadzu Corporation) was 1.0 μm. As a result, a color developer dispersion liquid (B liquid) was obtained.

### (4) Preparation of Sensitizer Dispersion Liquid (C Liquid)

Further, 40 parts of oxalic acid-di-p-methylbenzyl ester (trade name: HS-3520, manufactured by DIC Corporation), 40 parts of a 10% aqueous solution of polyvinyl alcohol (polymerization degree: 500, saponification degree: 88%), and 20 parts of water were mixed, and were pulverized using a sand mill (manufactured by IMEX Co., Ltd., a sand grinder) such that the median size obtained by a laser diffraction particle size analyzer SALD2200 (manufactured by Shimadzu Corporation) was 1.0 μm. As a result, a sensitizer dispersion liquid (C liquid) was obtained.

### (5) Preparation of Heat-Sensitive Recording Layer-Forming Coating Liquid

Further, 29.5 parts of the A liquid, 59.1 parts of the B liquid, 45.4 parts of the C liquid, 20 parts of a 5% aqueous solution of hydroxypropyl methyl cellulose, 46 parts of a 10% aqueous solution of completely saponified polyvinyl alcohol (trade name: PVA110, saponification degree: 99 mol %, average polymerization degree: 1000, manufactured by Kuraray Co., Ltd.), 9.4 parts of a butadiene copolymer latex (trade name: L-1571, manufactured by Asahi Kasei Corporation, solid content concentration: 48%), 25.4 parts of precipitated calcium carbonate (trade name: Brilliant-15, manufactured by Shiraishi Kogyo Kaisha, Ltd.), 11.7 parts of paraffin wax (trade name: HYDRIN L-700, manufactured by Chukyo Yushi Co., Ltd., solid content concentration: 30%), 2 parts of adipic acid dihydrazide (manufactured by Otsuka Chemical Co., Ltd.), and 120 parts of water were mixed and stirred to obtain a heat-sensitive recording layer-forming coating liquid.

### (6) Preparation of Protective Layer-Forming Coating Liquid

Further, 300 parts of a 12% aqueous solution of acetoacetyl modified polyvinyl alcohol (trade name: GOHSENX Z-200, saponification degree: 99.4 mol %, average polymerization degree: 1000, modification degree: 5 mol %, manufactured by Nippon Synthetic Chemical Industry Co., Ltd.), 19 parts of kaolin (trade name: HYDRAGLOSS90, manufactured by KaMin LLC.), 35 parts of aluminum hydroxide (trade name: HEIDI WRIGHT H-42M, manufactured by Showa Denko K.K.), 4 parts of silica (trade name: MIZUKASIL P-527, manufactured by Mizusawa Industrial Chemicals, Ltd.), 2.5 parts of polyethylene wax (trade name: CHEMIPEARL W-400, manufactured by Mitsui Chemicals, Inc., solid content concentration: 40%), and 114.5 parts of water were mixed and stirred to obtain a composition, and thus a protective layer-forming coating liquid was obtained.

### (7) Preparation of Heat-Sensitive Recording Material

The undercoat layer-forming coating liquid, the heat-sensitive recording layer-forming coating liquid, and the protective layer-recording coating liquid were applied to a single surface of high-quality paper having a basis weight of 60 g/m² such that the coating amounts thereof after drying were 4.0 g/m², 4.0 g/m², and 2.0 g/m², respectively, and were dried to sequentially form an undercoat layer, a heat-sensitive recording layer, and a protective layer. The surfaces of the layers were smoothed using a super calender to obtain a heat-sensitive recording material.

### Example C2

A heat-sensitive recording material was obtained using the same method as that of Example C1, except that during the preparation of the undercoat layer-forming coating liquid according to Example C1, the hollow particles B were used instead of the hollow particles A.

### Example C3

A heat-sensitive recording material was obtained using the same method as that of Example C1, except that during the preparation of the undercoat layer-forming coating liquid according to Example C1, the hollow particles C were used instead of the hollow particles A.

### Example C4

A heat-sensitive recording material was obtained using the same method as that of Example C1, except that during the preparation of the undercoat layer-forming coating liquid according to Example C1, the hollow particles D were used instead of the hollow particles A.

### Example C5

A heat-sensitive recording material was obtained using the same method as that of Example C3, except that during the preparation of the undercoat layer-forming coating liquid according to Example C3, the amount of the hollow particles C was changed to 40.0 parts and the amount of the fired kaolin was changed to 30.0 parts.

### Example C6

A heat-sensitive recording material was obtained using the same method as that of Example C3, except that during the preparation of the undercoat layer-forming coating liquid according to Example C3, the amount of the hollow particles C was changed to 186.7 parts and the amount of the fired kaolin was changed to 8.0 parts.

### Example C7

A heat-sensitive recording material was obtained using the same method as that of Example C3, except that during the preparation of the undercoat layer-forming coating liquid according to Example C3, the amount of the hollow particles C was changed to 26.7 parts and the amount of the fired kaolin was changed to 32.0 parts.

### Example C8

A heat-sensitive recording material was obtained using the same method as that of Example C3, except that during the preparation of the undercoat layer-forming coating liquid according to Example C3, the amount of the hollow particles C was changed to 213.3 parts and the amount of the fired kaolin was changed to 4.0 parts.

### Example C9

A heat-sensitive recording material was obtained using the same method as that of Example C3, except that during the preparation of the heat-sensitive recording material according to Example C3, the coating amount of the undercoat layer after drying was changed from 4.0 g/m² to 12.0 g/m².

### Example C10

A heat-sensitive recording material was obtained using the same method as that of Example C3, except that during the preparation of the heat-sensitive recording material according to Example C3, the coating amount of the undercoat layer after drying was changed from 4.0 g/m² to 8.0 g/m².

### Example C11

A heat-sensitive recording material was obtained using the same method as that of Example C3, except that during the preparation of the heat-sensitive recording material according to Example C3, the coating amount of the undercoat layer after drying was changed from 4.0 g/m² to 2.0 g/m².

### Example C12

A heat-sensitive recording material was obtained using the same method as that of Example C3, except that during the preparation of the undercoat layer-forming coating liquid according to Example C3, the amount of the hollow particles C was changed to 40.0 parts, the amount of the hollow particles J was changed to 249.1 parts, and the amount of the fired kaolin was changed to 0 part.

### Example C13

A heat-sensitive recording material was obtained using the same method as that of Example C3, except that during the preparation of the undercoat layer-forming coating liquid according to Example C3, the amount of the hollow particles C was changed to 186.7 parts, the amount of the hollow particle J was changed to 22.6 parts, and the amount of the fired kaolin was changed to 38.0 parts.

### Example C14

A heat-sensitive recording material was obtained using the same method as that of Example C3, except that during the preparation of the undercoat layer-forming coating liquid according to Example C3, the amount of the hollow particles C was changed to 186.7 parts, the amount of the hollow particles J was changed to 7.5 parts, and the amount of the fired kaolin was changed to 42.0 part.

### Example C15

A heat-sensitive recording material was obtained using the same method as that of Example C3, except that during the preparation of the undercoat layer-forming coating liquid according to Example C3, the latex A was changed to the latex B.

### Example C16

A heat-sensitive recording material was obtained using the same method as that of Example C3, except that during the preparation of the undercoat layer-forming coating liquid according to Example C3, the latex A was changed to the latex C.

### Example C17

A heat-sensitive recording material was obtained using the same method as that of Example C3, except that during the preparation of the undercoat layer-forming coating liquid according to Example C3, 276.9 parts of the hollow particles H were used instead of 135.8 parts of the hollow particles J.

### Example C18

A heat-sensitive recording material was obtained using the same method as that of Example C3, except that during the preparation of the undercoat layer-forming coating liquid according to Example C3, 240.0 parts of the hollow particles I were used instead of 135.8 parts of the hollow particles J.

### Example C19

A heat-sensitive recording material was obtained using the same method as that of Example C3, except that during the preparation of the color developer dispersion liquid according to Example C3, 4-hydroxyphenyl(4′-n-propoxyphenyl)sulfone (manufactured by Mitsubishi Chemical Corporation, TOMIRAC KN) was used instead of 4-hydroxy-4′-isopropoxydiphenylsulfone (manufactured by Nippon Soda Co., Ltd., D-8).

### Example C20

A heat-sensitive recording material was obtained using the same method as that of Example C3, except that during the preparation of the color developer dispersion liquid according to Example C3, 2-phenylsulfonylamino-N,N′-diphenylurea (manufactured by Nippon Soda Co., Ltd., NKK-1304) was used instead of 4-hydroxy-4′-isopropoxydiphenylsulfone (manufactured by Nippon Soda Co., Ltd., D-8).

### Example C21

A heat-sensitive recording material was obtained using the same method as that of Example C1, except that during the preparation of the undercoat layer-forming coating liquid according to Example C1, the hollow particles E were used instead of the hollow particles A.

### Comparative Example C1

A heat-sensitive recording material was obtained using the same method as that of Example C1, except that during the preparation of the undercoat layer-forming coating liquid according to Example C1, the hollow particles F were used instead of the hollow particles A.

### Comparative Example C2

A heat-sensitive recording material was obtained using the same method as that of Example C1, except that during the preparation of the undercoat layer-forming coating liquid according to Example C1, the hollow particles G were used instead of the hollow particles A.

### Comparative Example C3

A heat-sensitive recording material was obtained using the same method as that of Example C1, except that during the preparation of the undercoat layer-forming coating liquid according to Example C1, 138.5 parts of the hollow particles H were used instead of 120.0 parts of the hollow particles A.

### Comparative Example C4

A heat-sensitive recording material was obtained using the same method as that of Example C1, except that during the preparation of the undercoat layer-forming coating liquid according to Example C1, the hollow particles J were used instead of the hollow particles A.

### Comparative Example C5

A heat-sensitive recording material was obtained using the same method as that of Example C3, except that during the preparation of the undercoat layer-forming coating liquid according to Example C3, the amount of the hollow particles J was changed to 0 parts and the amount of ANSILEX 93 was changed to 54.0 parts.

Regarding each of the heat-sensitive recording materials according to Examples C1 to C21 and Comparative Examples C1 to C5, the following performance evaluation was performed, and the results are shown in Table 3.

[Halftone Recording Density]

Using a heat-sensitive recording evaluation tester (trade name: TH-PMD, manufactured by Ohkura-Denki), recording was performed on each of the heat-sensitive recording materials in a halftone energy range with printing energy: 0.16 mJ/dot, and the printed portion was measured in a visual mode of a Macbeth densitometer (RD-914, manufactured by Macbeth Corporation.). As the numerical value increases, the print density becomes higher. Regarding the recording density, it is assumed that 1.00 or more is needed in practice and 1.20 or more is more desirable.

[Print Image Quality]

Using a label printer (trade name: L-2000, manufactured by Ishida Co., Ltd.), a barcode was recorded, the recording image quality was observed by visual inspection and evaluated based on the following criteria.
A: the formation of white spots in an image or the thickening of the barcode did not occur, which were particularly excellent
B: the formation of white spots in an image or the thickening of the barcode did not occur, and there were no problems
C: the formation of white spots in an image or the thickening of the barcode did not substantially occur, and there were no problems in practice
D: the formation of white spots in an image or the thickening of the barcode occurred, and there were problems in practice

TABLE 3

| | Large Particle Size Hollow Particles | | | | | | | | | | | |
|---|---|---|---|---|---|---|---|---|---|---|---|---|
| | | | | | Ratio of | | | | | | | |
| | | | | | Particles having | | | Small Particle Size Hollow Particles | | | | |
| | | | | | Particle Size | | Part(s) | | | | | Part(s) |
| | | | | | of 2 μm or | Hollow | by | | | | Hollow | by |
| | Hollow | | | D100/ | less | Ratio | Mass | Hollow | | | Ratio | Mass |
| | Particles | D100 | D50 | D50 | (Vol %) | (%) | (X) | Particles | D100 | D50 | (%) | (Y) |
| Example C1 | A | 80 | 20 | 4.0 | 0.0 | 95 | 18 | J | 2 | 1 | 55 | 36 |
| Example C2 | B | 45 | 12 | 3.8 | 0.0 | 94 | 18 | J | 2 | 1 | 55 | 36 |
| Example C3 | C | 23 | 11 | 2.1 | 0.0 | 93 | 18 | J | 2 | 1 | 55 | 36 |
| Example C4 | D | 20 | 8.1 | 2.5 | 0.0 | 90 | 18 | J | 2 | 1 | 55 | 36 |
| Example C5 | C | 23 | 11 | 2.1 | 0.0 | 93 | 6 | J | 2 | 1 | 55 | 36 |
| Example C6 | C | 23 | 11 | 2.1 | 0.0 | 93 | 28 | J | 2 | 1 | 55 | 36 |
| Example C7 | C | 23 | 11 | 2.1 | 0.0 | 93 | 4 | J | 2 | 1 | 55 | 36 |
| Example C8 | C | 23 | 11 | 2.1 | 0.0 | 93 | 32 | J | 2 | 1 | 55 | 36 |
| Example C9 | C | 23 | 11 | 2.1 | 0.0 | 93 | 18 | J | 2 | 1 | 55 | 36 |
| Example C10 | C | 23 | 11 | 2.1 | 0.0 | 93 | 18 | J | 2 | 1 | 55 | 36 |
| Example C11 | C | 23 | 11 | 2.1 | 0.0 | 93 | 18 | J | 2 | 1 | 55 | 36 |
| Example C12 | C | 23 | 11 | 2.1 | 0.0 | 93 | 6 | J | 2 | 1 | 55 | 66 |
| Example C13 | C | 23 | 11 | 2.1 | 0.0 | 93 | 28 | J | 2 | 1 | 55 | 6 |
| Example C14 | C | 23 | 11 | 2.1 | 0.0 | 93 | 28 | J | 2 | 1 | 55 | 2 |
| Example C15 | C | 23 | 11 | 2.1 | 0.0 | 93 | 18 | J | 2 | 1 | 55 | 36 |
| Example C16 | C | 23 | 11 | 2.1 | 0.0 | 93 | 18 | J | 2 | 1 | 55 | 36 |
| Example C17 | C | 23 | 11 | 2.1 | 0.0 | 93 | 18 | H | 6.5 | 3.8 | 78 | 36 |
| Example C18 | C | 23 | 11 | 2.1 | 0.0 | 93 | 18 | I | 13.5 | 5 | 90 | 36 |
| Example C19 | C | 23 | 11 | 2.1 | 0.0 | 93 | 18 | J | 2 | 1 | 55 | 36 |
| Example C20 | C | 23 | 11 | 2.1 | 0.0 | 93 | 18 | J | 2 | 1 | 55 | 36 |
| Example C21 | E | 15 | 7.5 | 2.0 | 0.0 | 85 | 18 | J | 2 | 1 | 55 | 36 |
| Comparative | F | 124 | 12 | 10.3 | 0.0 | 94 | 18 | J | 2 | 1 | 55 | 36 |
| Example C1 | | | | | | | | | | | | |
| Comparative | G | 15 | 6.2 | 2.4 | 0.0 | 77 | 18 | J | 2 | 1 | 55 | 36 |
| Example C2 | | | | | | | | | | | | |
| Comparative | H | 6.5 | 3.8 | 1.7 | 1.6 | 78 | 18 | J | 2 | 1 | 55 | 36 |
| Example C3 | | | | | | | | | | | | |
| Comparative | I | 13.5 | 5 | 2.7 | 0.2 | 90 | 18 | J | 2 | 1 | 55 | 36 |
| Example C4 | | | | | | | | | | | | |
| Comparative | C | 23 | 11 | 2.1 | 0.0 | 93 | 18 | — | — | — | — | 0 |
| Example C5 | | | | | | | | | | | | |

| | | | | | Heat- | | |
|---|---|---|---|---|---|---|---|
| | | | | | sensitive | | |
| | | | | Coating | Recording | | |
| | | | | Amount of | Layer | | |
| | | | Latex | Undercoat | Color | Halftone | Print |
| | Y/X | Latex | Tg | Layer | Developer | Recording | Image |
| | Ratio | Kind | (° C.) | (g/m²) | Kind | Density | Quality |
| Example C1 | 2.0 | Latex A | −10 | 4 | D-8 | 1.03 | A |
| Example C2 | 2.0 | Latex A | −10 | 4 | D-8 | 1.13 | A |
| Example C3 | 2.0 | Latex A | −10 | 4 | D-8 | 1.24 | A |
| Example C4 | 2.0 | Latex A | −10 | 4 | D-8 | 1.25 | B |
| Example C5 | 2.0 | Latex A | −10 | 4 | D-8 | 1.20 | B |
| Example C6 | 2.0 | Latex A | −10 | 4 | D-8 | 1.21 | A |
| Example C7 | 2.0 | Latex A | −10 | 4 | D-8 | 1.05 | C |
| Example C8 | 1.1 | Latex A | −10 | 4 | D-8 | 1.15 | A |
| Example C9 | 2.0 | Latex A | −10 | 12 | D-8 | 1.06 | A |
| Example C10 | 2.0 | Latex A | −10 | 8 | D-8 | 1.20 | A |
| Example C11 | 2.0 | Latex A | −10 | 2 | D-8 | 1.05 | C |
| Example C12 | 11.0 | Latex A | −10 | 4 | D-8 | 1.20 | C |
| Example C13 | 0.2 | Latex A | −10 | 4 | D-8 | 1.13 | A |
| Example C14 | 0.07 | Latex A | −10 | 4 | D-8 | 1.04 | A |
| Example C15 | 2.0 | Latex B | −35 | 4 | D-8 | 1.28 | A |
| Example C16 | 2.0 | Latex C | −3 | 4 | D-8 | 1.10 | C |
| Example C17 | 2.0 | Latex A | −10 | 4 | D-8 | 1.12 | A |
| Example C18 | 2.0 | Latex A | −10 | 4 | D-8 | 1.01 | A |
| Example C19 | 2.0 | Latex A | −10 | 4 | TOMIRAC KN | 1.29 | A |
| Example C20 | 2.0 | Latex A | −10 | 4 | NKK-1304 | 1.21 | A |
| Example C21 | 2.0 | Latex A | −10 | 4 | D-8 | 1.10 | C |
| Comparative | 2.0 | Latex A | −10 | 4 | D-8 | 0.88 | A |
| Example C1 | | | | | | | |
| Comparative | 2.0 | Latex A | −10 | 4 | D-8 | 1.02 | D |
| Example C2 | | | | | | | |
| Comparative | 2.0 | Latex A | −10 | 4 | D-8 | 0.90 | D |
| Example C3 | | | | | | | |
| Comparative | 2.0 | Latex A | −10 | 4 | D-8 | 1.08 | D |
| Example C4 | | | | | | | |
| Comparative | 0.0 | Latex A | −10 | 4 | D-8 | 0.96 | A |
| Example C5 | | | | | | | |

As can be seen from Table 3, the heat-sensitive recording materials according to Examples C1 to C21 had excellent halftone recording density and print image quality.

In the heat-sensitive recording material according to Comparative Example C1, the maximum particle size (D100) of the first hollow particles was more than 80 μm. Therefore, the smoothness of the undercoat layer deteriorated, the heat-sensitive recording layer-forming coating liquid was not uniformly applied, and the halftone recording density was poor.

In the heat-sensitive recording materials according to Comparative Examples C2 to C4, the median size (D50) of the first hollow particles was less than 7.5 μm. Therefore, the thermal insulation properties of the undercoat layer were insufficient, and the print image quality was poor.

In particular, in the heat-sensitive recording material according to Comparative Example C3, the maximum particle size (D100) of the first hollow particles was less than 10 μm. Therefore, the cushioning properties deteriorated, and the halftone recording density was poor.

In the heat-sensitive recording material according to Comparative Example C5, the second hollow particles were not used. Therefore, the smoothness of the undercoat layer deteriorated, the heat-sensitive recording layer-forming coating liquid was not uniformly applied, and the halftone recording density was poor.

1. A heat-sensitive recording material comprising
an undercoat layer and a heat-sensitive recording layer on a support in this order, wherein:
the undercoat layer contains hollow particles;
the heat-sensitive recording layer contains a leuco dye and a color developer; and
the heat-sensitive recording material has one characteristic selected from a group consisting of following (A) to (C) characteristics:
(A) the undercoat layer further contains an adhesive and a water retention agent and a maximum particle size of the hollow particles is 10 μm to 30 μm;
(B) an average particle size of the hollow particles is 3 μm to 20 μm and the heat-sensitive recording layer further contains an inorganic layered compound; and
(C) the undercoat layer further contains an adhesive, the hollow particles include at least two kinds of hollow particles including large particle size hollow particles and small particle size hollow particles, a maximum particle size of the large particle size hollow particles is 10 μm to 80 μm, an average particle size of the large particle size hollow particles is 7.5 μm to 25 μm, and an average particle size of the small particle size hollow particles is 0.7 μm to 6 μm.

2. The heat-sensitive recording material according to claim 1, wherein the heat-sensitive recording material has the characteristic (A).

3. The heat-sensitive recording material according to claim 2, wherein the adhesive in the undercoat layer is a water-dispersible adhesive formed of a water-insoluble resin.

4. The heat-sensitive recording material according to claim 3, wherein the water-insoluble resin is a styrene-butadiene copolymer.

5. The heat-sensitive recording material according to claim 4, wherein a glass transition temperature of the styrene-butadiene copolymer is 10° C. or lower.

6. The heat-sensitive recording material according to claim 4, wherein an average particle size of the styrene-butadiene copolymer is 150 nm to 300 nm.

7. The heat-sensitive recording material according to claim 2, wherein the water retention agent in the undercoat layer is a water-soluble water retention agent formed of a water-soluble resin.

8. The heat-sensitive recording material according to claim 7, wherein the water-soluble resin is at least one kind selected from a group consisting of starch, polyvinyl alcohol, and carboxymethyl cellulose.

9. The heat-sensitive recording material according to claim 2, wherein a hollow ratio of the hollow particles is 65% or more.

10. The heat-sensitive recording material according to claim 2, wherein a content ratio of the hollow particles is 5 mass % to 90 mass % with respect to a total solid content of the undercoat layer.

11. A method of manufacturing the heat-sensitive recording material according to claim 2, the method comprising applying an undercoat layer-forming coating material containing hollow particles, an adhesive, and a water retention agent using a curtain coating method.

12. The heat-sensitive recording material according to claim 1, wherein the heat-sensitive recording material has the characteristic (B).

13. The heat-sensitive recording material according to claim 12, wherein the inorganic layered compound is a water-swellable synthetic mica.

14. The heat-sensitive recording material according to claim 12, wherein an average particle size of the inorganic layered compound is 2 μm to 15 μm.

15. A method of manufacturing the heat-sensitive recording material according to claim 12, the method comprising applying a heat-sensitive recording layer-forming coating material containing a leuco dye, a color developer, and an inorganic layered compound using a curtain coating method.

16. The heat-sensitive recording material according to claim 1, wherein the heat-sensitive recording material has the characteristic (C).

17. The heat-sensitive recording material according to claim 16, wherein the maximum particle size of the large particle size hollow particles is 10 μm to 50 μm and the average particle size of the large particle size hollow particles is 7.5 μm to 15 μm.

18. The heat-sensitive recording material according to claim 16, wherein D100/D50 of the large particle size hollow particles is 1.8 to 10.0, D100 representing the maximum particle size, and D50 representing the average particle size.

19. The heat-sensitive recording material according to claim 16, wherein a hollow ratio of the large particle size hollow particles is 80% to 98% and a hollow ratio of the small particle size hollow particles is less than 80%.

20. The heat-sensitive recording material according to claim 16, wherein the undercoat layer contains 5 mass % to 40 mass % of the large particle size hollow particles.

21. The heat-sensitive recording material according to claim 16, wherein a coating amount of the undercoat layer after drying is 2.0 g/m² to 10 g/m².

22. The heat-sensitive recording material according to claim 16, wherein a ratio of the small particle size hollow particles to 1 part by mass of the large particle size hollow particles is 0.1 parts by mass to 10 parts by mass.

23. The heat-sensitive recording material according to claim 16, wherein a maximum particle size of the small particle size hollow particles is 1 μm to 7 μm.

24. The heat-sensitive recording material according to claim 16, wherein styrene-butadiene latex is contained as the adhesive.

25. The heat-sensitive recording material according to claim 24, wherein a glass transition temperature of the styrene-butadiene latex is −10° C. or lower.

26. A method of manufacturing the heat-sensitive recording material according to claim 16, the method comprising applying an undercoat layer-forming coating material containing hollow particles and an adhesive using a curtain coating method,
wherein the hollow particles include at least two kinds of hollow particles including large particle size hollow particles and small particle size hollow particles, a maximum particle size of the large particle size hollow particles is 10 μm to 80 μm, an average particle size of the large particle size hollow particles is 7.5 μm to 25 μm, and an average particle size of the small particle size hollow particles is 0.7 μm to 6 μm.
